(19) United States
(12) Patent Application Publication
(10) Pub. No.: US 2024/0417252 A1
(43) Pub. Date: Dec. 19, 2024

(54) ORGANIC WORKING SOLUTION FOR PHOTOCHEMICAL HYDROGEN PEROXIDE PRODUCTION AND METHOD FOR PRODUCING HYDROGEN PEROXIDE BY PHOTO-AUTOXIDATION UTILIZING THE SAME

(71) Applicant: KOREA INSTITUTE OF SCIENCE AND TECHNOLOGY, Seoul (KR)

(72) Inventors: Jee Hye BYUN, Seoul (KR); Dong Ki LEE, Seoul (KR)

(21) Appl. No.: 18/236,489

(22) Filed: Aug. 22, 2023

(30) Foreign Application Priority Data
Jun. 13, 2023 (KR) 10-2023-0075434

(51) Int. Cl. C01B 15/026

(52) U.S. Cl. CPC C01B 15/026

(57) ABSTRACT

The present invention relates to an organic working solution for photochemical hydrogen peroxide production, and a method for producing hydrogen peroxide by photo-autoxidation utilizing the organic working solution.

Specifically, the present invention relates to a method for producing hydrogen peroxide from an organic working solution in which oxidation of an aromatic alcohol and reduction of oxygen occur through photo-autoxidation of an aromatic carbonyl compound contained in the organic working solution, and the reduced oxygen.

### CROSS-REFERENCE TO RELATED APPLICATION

This application claims priority to and the benefit of Korean Patent Application No. 10-2023-0075434 filed in the Korean Intellectual Property Office on Jun. 13, 2023, and Korean Patent Application No. filed in the Korean Intellectual Property Office on, the entire contents of which are incorporated herein by reference.

### BACKGROUND OF THE INVENTION

### (a) Field of the Invention

The present invention relates to an organic working solution for photochemical hydrogen peroxide production, and a method for producing hydrogen peroxide by photo-autoxidation utilizing the organic working solution. Specifically, the present invention relates to a method for producing hydrogen peroxide from an organic working solution in which oxidation of an aromatic alcohol and reduction of oxygen occur through photo-autoxidation reaction of an aromatic carbonyl compound contained in the organic working solution, and the reduced oxygen.

### (b) Description of the Related Art

In the industrial production of hydrogen peroxide, 90% or more of the total hydrogen peroxide is done by an anthraquinone autooxidation process. The anthraquinone autooxidation process is a method for producing hydrogen peroxide by reducing oxygen molecules in a repetitive oxidation/reduction cycle of anthraquinone molecules. The process proceeds under reaction conditions of a high temperature of 50° C. degrees or more and a high pressure of 4 bar or more, and thus requires a large amount of energy and high cost. In addition, the use of rare metal catalysts such as palladium (Pd) in the process may be a factor that increases the cost. In particular, the rare metals used as catalysts may not be easy to procure due to their high dependence on resource imports.

The anthraquinone autooxidation process causes problems economically as well as environmentally. Environmental problems may also be caused, such as the generation of carbon in large quantities by the high-temperature and high-pressure processes and the generation of toxic reaction by-products due to the use of metal catalysts. In addition, since the process uses hydrogen (H₂) gas, there is a risk of explosion.

In addition to the problems associated with the process itself, there is an increasing need for technology to produce hydrogen peroxide in an effective eco-friendly and low-carbon manner in industrial fields. In fact, since a relatively low concentration (less than 2 wt %) of hydrogen peroxide is used in a water treatment plant or a semiconductor cleaning process, which is a large demand for hydrogen peroxide, technology to produce hydrogen peroxide in the field in a distributed manner may be highly effective. Currently, eco-friendly technologies for producing hydrogen peroxide include electrochemical technology and photocatalytic technology, but it is difficult to put it into practical use due to clear limitations in performance, production scale, purification cost, and the like.

Hydrogen peroxide production technology in a form that may be used at industrial fields produces hydrogen peroxide in an eco-friendly and low-carbon manner, but a hydrogen peroxide production level required by the actual industry is required.

### SUMMARY OF THE INVENTION

The present invention attempts to provide a method for producing hydrogen peroxide in an eco-friendly and low-carbon manner that simulates an industrial thermochemical hydrogen peroxide production method by a photochemical method, capable of achieving ultra-high efficiency of hydrogen peroxide production ability.

Specifically, the present invention attempts to provide an organic working solution composed of an aromatic alcohol, an aromatic carbonyl compound, and an organic solvent that may be utilized in photochemical hydrogen peroxide production, and a method for producing hydrogen peroxide by a photo-autoxidation process utilizing the organic working solution.

An exemplary embodiment of the present provides an organic working solution used for producing hydrogen peroxide by photo-autoxidation, wherein the organic working solution contains a mixture of an aromatic alcohol and an organic solvent, and the aromatic alcohol contains 0.1% to 0.2% by weight of an aromatic carbonyl compound based on the total weight of the aromatic alcohol.

The organic working solution according to another embodiment of the present invention contains an additionally mixed aromatic carbonyl compound.

Another embodiment of the present invention provides a method for producing hydrogen peroxide by photo-autoxidation utilizing an organic working solution, including: preparing an organic working solution for photo-autoxidation and introducing the organic working solution into a reactor; supplying oxygen to the reactor to form an oxygen-saturated mixed solution; and irradiating the oxygen-saturated mixed solution with light to produce hydrogen peroxide.

The method for producing hydrogen peroxide according to embodiment may generate hydrogen peroxide through photo-autoxidation reaction of an organic working solution containing an aromatic carbonyl compound that absorbs solar light.

Since an oxidation process is performed by light energy in the organic working solution, energy consumption may be minimized.

Hydrogen peroxide production efficiency may be improved by a photo-autoxidation reaction using the organic working solution.

Due to an auto-oxidation phenomenon in which the aromatic carbonyl compound in the organic working solution becomes an organic oxidation reaction product while being a catalyst, the entire organic working solution serves as a catalyst, such that quantum efficiency may be maximized.

### BRIEF DESCRIPTION OF THE DRAWINGS

FIG. 1 illustrates a production amount of hydrogen peroxide depending on an amount of water added in an organic working solution composed of benzyl alcohol and acetonitrile according to an embodiment of the present invention.

FIG. 2 illustrates a production amount of benzaldehyde, which is an oxidized organic product, produced depending on the amount of water added in an organic working solution composed of benzyl alcohol and acetonitrile according to an embodiment of the present invention.

FIG. 3 illustrates a solar-chemical conversion efficiency depending on the amount of water added in an organic working solution composed of benzyl alcohol and acetonitrile according to an embodiment of the present invention.

FIG. 4 illustrates chromatography for detecting a catalytic amount of benzaldehyde (BzCHO) contained in the initial benzyl alcohol solution according to an embodiment of the present invention.

FIG. 5 illustrates a production amount of hydrogen peroxide depending on a wavelength region of light irradiated in a photochemical reaction utilizing an organic working solution according to an embodiment of the present invention.

FIG. 6 illustrates an amount of benzaldehyde produced depending on a wavelength region of light irradiated in a photochemical reaction utilizing an organic working solution according to an embodiment of the present invention.

FIG. 7 illustrates a change in light absorption wavelength of an acetonitrile solution depending on to a concentration of benzyl alcohol in a photochemical reaction utilizing an organic working solution according to an embodiment of the present invention.

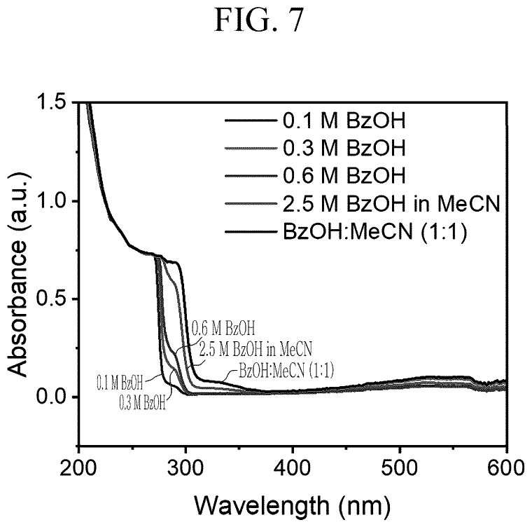

FIG. 8 illustrates a change in light absorption wavelength of an acetonitrile solution depending on to a concentration of benzaldehyde in a photochemical reaction utilizing an organic working solution according to an embodiment of the present invention.

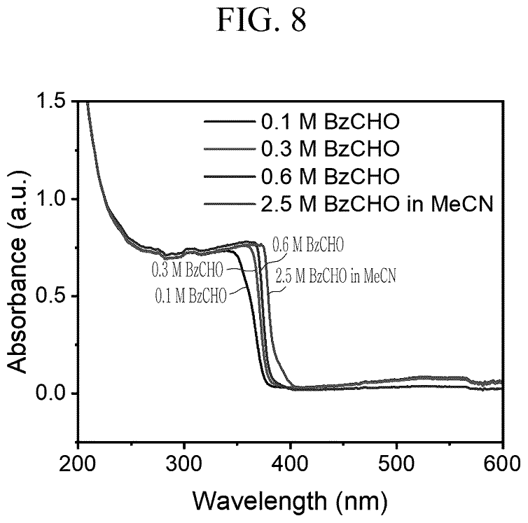

FIG. 9 illustrates a production amount of hydrogen peroxide depending on a structure of an aromatic alcohol in a hydrogen peroxide production reaction by photo-autoxidation in an organic working solution according to an embodiment of the present invention.

FIG. 10 illustrates a photochemical hydrogen peroxide production efficiency of an organic working solution depending on a ratio of benzyl alcohol in acetonitrile according to an embodiment of the present invention.

FIG. 11 illustrates the photochemical hydrogen peroxide production efficiency of an organic working solution according to the ratio of benzyl alcohol in acetonitrile according to an embodiment of the present invention.

FIG. 12 illustrates a photochemical hydrogen peroxide production ability depending on the type of organic solvent in an organic working solution containing 70% of benzyl alcohol or benzyl alcohol substituted with a methyl group (α-methylbenzyl alcohol, α-m-BzOH) according to an embodiment of the present invention.

FIG. 13 illustrates a hydrogen peroxide production ability under solar irradiation depending on an amount of benzaldehyde added in an organic working solution containing benzyl alcohol as a hydrogen donor according to an embodiment of the present invention.

FIG. 14 illustrates a hydrogen peroxide production ability under solar irradiation depending on an amount of benzaldehyde added in an organic working solution containing benzyl alcohol (α-methylbenzyl alcohol, α-m-BzOH) substituted with a methyl group as a hydrogen donor according to an embodiment of the present invention.

FIG. 15 illustrates a photochemical hydrogen peroxide production mechanism in an organic working solution according to an embodiment of the present invention.

FIG. 16 illustrates a real-time observation EPR spectrum of photochemically active species generated in an organic working solution according to an embodiment of the present invention.

### DETAILED DESCRIPTION OF THE EMBODIMENTS

Technical terms used herein are to mention only a specific exemplary embodiment, and are not to limit the present invention. Singular forms used herein include plural forms as long as phrases do not clearly indicate an opposite meaning. A term “including” as used herein concretely indicates specific properties, regions, integer numbers, steps, operations, elements, and/or components, and is not to exclude presence or addition of other properties, regions, integer numbers, steps, operations, elements, and/or components.

All terms including technical terms and scientific terms as used herein have the same meaning as commonly understood by a person of ordinary skill in the art to which the present invention belongs.

Hereinafter, an exemplary embodiment of the present invention will be described in detail. However, it is to be understood that this exemplary embodiment is provided as an example, and the present invention is not limited by this exemplary embodiment, but is defined by only the scope of claims to be described below.

An organic working solution according to an embodiment of the present invention may be an organic working solution used for Production of hydrogen peroxide by photo-autoxidation. The organic working solution contains a mixture of an aromatic alcohol and an organic solvent, and the aromatic alcohol is partially oxidized to include 0.1% to 0.2% by weight of an aromatic carbonyl compound based on the total weight of the aromatic alcohol, and the aromatic carbonyl compound may be an auto-catalyst for the photo-autoxidation.

Specifically, the aromatic carbonyl compound contained in 0.1% to 0.2% by weight corresponds to one that is self-oxidized and contained in the aromatic alcohol. In addition, the aromatic carbonyl compound contained by oxidizing some of the aromatic alcohol may serve as a catalyst and an auto-catalyst that becomes an oxidation reaction product in the organic working solution.

The organic working solution may contain an additionally mixed an aromatic carbonyl compound.

The additionally mixed aromatic carbonyl compound may be one or more selected among an aromatic ketone or an aromatic aldehyde.

Specifically, the aromatic ketone or the aromatic aldehyde may be one or more selected among benzaldehyde (BzCHO), 9-anthracenecarboxaldehyde, 9-anthraldehyde, 9-phenanthrenecarboxaldehyde, fluorene-2-carboxaldehyde, 1-pyrenecarboxaldehyde, 1-naphthaldehyde, 2-naphthaldehyde, biphenyl-4-carboxaldehyde, benzophenone, 4-methylbenzaldehyde (p-tolualdehyde), 3-methylbenzaldehyde (m-tolualdehyde), 2-methylbenzaldehyde (o-tolualdehyde), 4-chlorobenzaldehyde, 3-chlorobenzaldehyde, 2-chlorobenzaldehyde, 4-fluorobenzaldehyde, 3-fluorobenzaldehyde, 2-fluorobenzaldehyde, 4-bromobenzaldehyde, 3-bromobenzaldehyde, 2-bromobenzaldehyde, 1-(p-tolyl)ethanone, 1-(4-fluorophenyl)ethanone, p-anisaldehyde, 4-formylbenzonitrile, 4-methoxyacetophenone, 4-acetylbenzonitrile, anthraquinone, fluorenone, acetophenone, xanthone, and thioxanthone.

The aromatic carbonyl compound may be additionally mixed in a range of 0.001 vol % to 30 vol % based on the total volume of a mixture of the aromatic alcohol, the organic solvent, and the additionally mixed aromatic carbonyl compound.

When the aromatic carbonyl compound is contained in an amount of 0.001% to 30% by volume based on the total volume of a mixture of the aromatic alcohol, the organic solvent, and the additionally mixed aromatic carbonyl compound, light absorption and photo-autoxidation reaction of the aromatic carbonyl compound are promoted, thereby improving the hydrogen peroxide production ability. On the other hand, when the aromatic carbonyl compound is contained in an amount of less than 0.001% by volume, the effect of photo-autoxidation by the aromatic carbonyl may be insignificant. In addition, when the aromatic carbonyl compound is contained in an amount of more than 30% by volume, aromatic radicals generated during the reaction of the organic working solution are homocoupled to produce organic by-products rather than hydrogen peroxide production, which may be disadvantageous in terms of hydrogen peroxide production efficiency.

The aromatic alcohol may be one or more selected from the group consisting of the benzyl alcohol substituted with electron-withdrawing and electron-donating functional groups.

Specifically, the group consisting of the benzyl alcohol substituted with the electron-withdrawing and electron-donating functional groups may include benzyl alcohol (BzOH), 4-fluorobenzyl alcohol (F-BzOH), 3-fluorobenzyl alcohol, 2-fluorobenzyl alcohol, 4-methylbenzyl alcohol (M-BzOH), 3-methylbenzyl alcohol, 2-methylbenzyl alcohol, α-methylbenzyl alcohol (α-M-BzOH), diphenylmethanol (DPM), and cinnamyl alcohol.

The aromatic alcohol may be mixed in a volume ratio of 1:99 to 99:1 based on a volume of the organic solvent mixed in the organic working solution. The aromatic alcohol may be preferably mixed in a volume ratio of 30:70 to 90:10. The aromatic alcohol may be more preferably be mixed in a volume ratio of 50:50 to 90:10.

An oxygen solubility of the organic solvent may be 1 mM to 15 mM based on 1 atm. Specifically, when the oxygen solubility of the organic solvent is in the range of 1 mM to 15 mM based on 1 atm, the oxygen concentration in the organic working solution is high, so that the activation of oxygen is increased in the photo-autoxidation reaction, thereby increasing the production rate of hydrogen peroxide. On the other hand, when the oxygen solubility is less than 1 mM, the hydrogen peroxide production rate may be slowed down. In addition, when the oxygen solubility exceeds 15 mM, since it is necessary to increase the oxygen gas pressure in the organic working solution, the amount of energy added to the reaction may be increased, and thus energy efficiency may be reduced.

The organic solvent includes a hydrophobic organic solvent, and an octanol-water partition coefficient (log P) value of the hydrophobic organic solvent represented by the following Equation 1 is 0 or more:

Octanol-water partition coefficient=log P=log([C_{oct}]/[C_{water}]) [Equation 1]
wherein [C_{oct}] refers to a mol concentration of the organic solvent dissolved in an octanol layer, and [C_{water}] refers to a mol concentration of the organic solvent dissolved in a water layer.

When an organic working solution is prepared using an organic solvent having log P of 0 or more, hydrogen peroxide produced after the hydrogen peroxide production reaction may be extracted with water. However, when the octanol-water partition coefficient value is less than 0, in a process of extracting hydrogen peroxide formed in the organic working solution with water, it is difficult to extract hydrogen peroxide due to mixing between the organic working solution and water, and at the same time, the purity of the extracted hydrogen peroxide solution may be lowered.

Specifically, the organic solvent may be one or more selected among trifluorotoluene, acetonitrile, methanol, ethanol, tert-butanol, 1-propanol, 2-propanol, acetone, ethyl acetate, tert-amyl alcohol, 1-butanol, petroleum ether, pentane, cyclohexane, n-hexane, dichloromethane, chloroform, tetrahydrofuran, 1,4-dioxane, toluene, dimethyl sulfoxide (DMSO), dimethylformamide, 1,2-dichloroethane, 1-octanol, benzonitrile, butanone, cyclohexanone, methyl tert-butyl ether, 2-hexanone, butyl acetate, trichloroethylene, xylene, and ethyl benzene.

A method for producing hydrogen peroxide by photo-autoxidation utilizing an organic working solution according to another embodiment of the present invention may include preparing an organic working solution for photo-autoxidation and introducing the organic working solution into a reactor; supplying oxygen to the reactor to form an oxygen-saturated mixed solution; and irradiating the oxygen-saturated mixed solution with light to produce hydrogen peroxide.

In the preparing of the mixed solution by performing the mixing of the organic working solution for photo-autoxidation, the organic working solution contains a mixture of an aromatic alcohol and an organic solvent, and the aromatic alcohol is partially oxidized to contain 0.1% to 0.2% by weight of an aromatic carbonyl compound based on the total weight of the aromatic alcohol, and the aromatic carbonyl compound may be an auto-catalyst for the photo-autoxidation.

Specifically, the aromatic carbonyl compound contained in 0.1% to 0.2% by weight corresponds to one that is self-oxidized and contained in the aromatic alcohol. In addition, the aromatic carbonyl compound contained by oxidizing some of the aromatic alcohol may serve as a catalyst and an auto-catalyst that becomes an oxidation reaction product in the organic working solution.

The organic working solution may contain an additionally mixed an aromatic carbonyl compound.

The additionally mixed aromatic carbonyl compound may be one or more selected among an aromatic ketone or an aromatic aldehyde.

Specifically, the aromatic ketone or the aromatic aldehyde may be one or more selected among benzaldehyde (BzCHO), 9-anthracenecarboxaldehyde, 9-anthraldehyde, 9-phenanthrenecarboxaldehyde, fluorene-2-carboxaldehyde, 1-pyrenecarboxaldehyde, 1-naphthaldehyde, 2-naphthaldehyde, biphenyl-4-carboxaldehyde, benzophenone, 4-methylbenzaldehyde (p-tolualdehyde), 3-methylbenzaldehyde (m-tolualdehyde), 2-methylbenzaldehyde (o-tolualdehyde), 4-chlorobenzaldehyde, 3-chlorobenzaldehyde, 2-chlorobenzaldehyde, 4-fluorobenzaldehyde, 3-fluorobenzaldehyde, 2-fluorobenzaldehyde, 4-bromobenzaldehyde, 3-bromobenzaldehyde, 2-bromobenzaldehyde, 1-(p-tolyl)ethanone, 1-(4-fluorophenyl)ethanone, p-anisaldehyde, 4-formylbenzonitrile, 4-methoxyacetophenone, 4-acetylbenzonitrile, anthraquinone, fluorenone, acetophenone, xanthone, and thioxanthone.

The aromatic carbonyl compound may be additionally mixed in a range of 0.001 vol % to 30 vol % based on the total volume of a mixture of the aromatic alcohol, the organic solvent, and the additionally mixed aromatic carbonyl compound.

When the aromatic carbonyl compound is contained in the range of 0.001% to 30% by volume based on the total volume of a mixture of the aromatic alcohol, the organic solvent, and the additionally mixed aromatic carbonyl compound, light absorption and photo-autoxidation reaction of the aromatic carbonyl compound are promoted, thereby improving the hydrogen peroxide production ability. On the other hand, when the aromatic carbonyl compound is contained in an amount of less than 0.001% by volume, the effect of photo-autoxidation by the aromatic carbonyl may be insignificant. In addition, when the aromatic carbonyl compound is contained in an amount of more than 30% by volume, aromatic radicals generated during the reaction of the organic working solution are homocoupled to produce organic by-products rather than hydrogen peroxide production, which may be disadvantageous in terms of hydrogen peroxide production efficiency.

The aromatic alcohol may include one or more selected from the group consisting of the benzyl alcohol substituted with electron-withdrawing and electron-donating functional groups.

Specifically, the group consisting of the benzyl alcohol substituted with the electron-withdrawing and electron-donating functional groups may include benzyl alcohol (BzOH), 4-fluorobenzyl alcohol (F-BzOH), 3-fluorobenzyl alcohol, 2-fluorobenzyl alcohol, 4-methylbenzyl alcohol (M-BzOH), 3-methylbenzyl alcohol, 2-methylbenzyl alcohol, α-methylbenzyl alcohol (α-M-BzOH), diphenylmethanol (DPM), and cinnamyl alcohol.

The aromatic alcohol may be mixed in a volume ratio of 1:99 to 99:1 based on a volume of the organic solvent mixed in the organic working solution. The aromatic alcohol may be preferably mixed in a volume ratio of 30:70 to 90:10. The aromatic alcohol may be more preferably be mixed in a volume ratio of 50:50 to 90:10.

The oxygen solubility of the organic solvent may be 1 mM to 15 mM based on 1 atm. Specifically, when the oxygen solubility of the organic solvent is in the range of 1 mM to 15 mM based on 1 atm, the oxygen concentration in the organic working solution is high, so that the activation of oxygen is increased in the photo-autoxidation reaction, thereby increasing the production rate of hydrogen peroxide. On the other hand, when the oxygen solubility is less than 1 mM, the hydrogen peroxide production rate may be slowed down. In addition, when the oxygen solubility exceeds 15 mM, since it is necessary to increase the oxygen gas pressure in the organic working solution, the amount of energy added to the reaction may be increased, and thus energy efficiency may be reduced.

The organic solvent includes a hydrophobic organic solvent, and an octanol-water partition coefficient (log P) value of the hydrophobic organic solvent represented by the following Equation 1 is 0 or more:

Octanol-water partition coefficient=log P=log([C_{oct}]/[C_{water}]) [Equation 1]
wherein [C_{oct}] refers to a mol concentration of the organic solvent dissolved in an octanol layer, and [C_{water}] refers to a mol concentration of the organic solvent dissolved in a water layer.

When an organic working solution is prepared using an organic solvent having log P of 0 or more, hydrogen peroxide produced after the hydrogen peroxide production reaction may be extracted with water. However, when the octanol-water partition coefficient value is less than 0, in a process of extracting hydrogen peroxide formed in the organic working solution with water, it is difficult to extract hydrogen peroxide due to mixing between the organic working solution and water, and at the same time, the purity of the extracted hydrogen peroxide solution may be lowered.

Specifically, the organic solvent may include one or more selected among trifluorotoluene, acetonitrile, methanol, ethanol, tert-butanol, 1-propanol, 2-propanol, acetone, ethyl acetate, tert-amyl alcohol, 1-butanol, petroleum ether, pentane, cyclohexane, n-hexane, dichloromethane, chloroform, tetrahydrofuran, 1,4-dioxane, toluene, dimethyl sulfoxide (DMSO), dimethylformamide, 1,2-dichloroethane, 1-octanol, benzonitrile, butanone, cyclohexanone, methyl tert-butyl ether, 2-hexanone, butyl acetate, trichloroethylene, xylene, and ethyl benzene.

Water may be additionally added to the organic working solution. In addition, the small amount of water may function to promote the photo-autoxidation reaction by hydrogen bonding with the aromatic alcohol or aromatic carbonyl to be reacted in the photo-autoxidation reaction. On the other hand, the small amount of water may also function to inhibit the reaction by quenching the aromatic radicals generated in the photo-autoxidation reaction. When the photo-autoxidation reaction was performed in the organic working solution according to an embodiment of the present invention, the addition of water tended to slightly inhibit the reaction. However, this is only one aspect of one embodiment, and if some of the conditions for the aromatic alcohol, organic solvent, and additionally mixed aromatic carbonyl compound proposed in the present invention are applied with changes, the small amount of water may also result in promoting the photo-autoxidation reaction. That is, although the contents of the invention presented herein may be partially modified and applied to a method for producing hydrogen peroxide, whether or not to add water to the organic working solution may be selected by those skilled in the art by determining whether there is an advantage to the photo-autoxidation reaction.

In the supplying of the oxygen to the reactor to form the oxygen-saturated mixed solution after introducing the prepared mixed solution into the reactor, an oxygen supply rate may be in a range of 10 mL/min to 50 mL/min.

Specifically, when the oxygen supply rate is in the range of 10 mL/min to 50 mL/min, a sufficient amount of oxygen may be supplied to the organic working solution to maximize hydrogen peroxide production ability. On the other hand, when the oxygen supply rate is less than 10 mL/min, the amount of oxygen in the working solution is small, so that the production amount of hydrogen peroxide may be lowered. In addition, when the oxygen supply rate exceeds 10 mL/min, the organic solvent may be evaporated during a process of filling the organic working solution with oxygen, and the stability of the reaction may be lowered due to an increase in pressure caused by oxygen.

In the supplying of the oxygen to the reactor to form the oxygen-saturated mixed solution after introducing the prepared mixed solution into the reactor, an oxygen supply time may be in a range of 15 min to 60 min.

Specifically, when the oxygen supply time is in the range of 15 min to 60 min, a sufficient amount of oxygen may be supplied to the organic working solution to maximize hydrogen peroxide production ability. On the other hand, when the oxygen supply time is less than 15 min, the amount of oxygen in the working solution is small, so that the production amount of hydrogen peroxide may be lowered. In addition, when the oxygen supply time exceeds 60 min, since oxygen is supplied in excess while the oxygen concentration in the working solution is saturated, it may be disadvantageous in terms of process operation cost.

In the irradiating of the oxygen-saturated mixed solution with the light to produce the hydrogen peroxide, light having a light wavelength of 200 nm to 500 nm band may be irradiated. More preferably, light having a light wavelength of 230 nm to 400 nm band may be irradiated. A light source having a corresponding light wavelength may be a simulated sunlight source or a short-wavelength lamp. Specifically, the simulated sunlight source includes a wavelength of 200 nm to 1000 nm band, and a short-wavelength lamp includes a 200 nm to 400 nm band. In addition, the short-wavelength lamp may be a UV lamp with an average wavelength of 352 nm including a UVA region with a wavelength of 315 nm to 400 nm. Specifically, when the light wavelength band is in the range of 200 nm to 500 nm, it corresponds to the light absorption regions of the aromatic alcohol and aromatic carbonyl compound in the organic working solution, and thus the reaction performance may be maximized. On the other hand, when the light wavelength band is less than 200 nm, it is outside the light absorption regions of the organic working solution, and the organic material may be decomposed by strong ultraviolet rays. In addition, when the light wavelength band exceeds 500 nm, it is outside the light absorption regions of the aromatic alcohol and the aromatic carbonyl compound in the organic working solution. Thus, the reaction efficiency is rapidly reduced, which may be disadvantageous in terms of hydrogen peroxide production.

In the irradiating of the oxygen-saturated mixed solution with the light to produce the hydrogen peroxide,
the light may be irradiated for 0 to 60 hours, and an irradiation time of the light may exceed 0. In one embodiment of the present invention, production of hydrogen peroxide was confirmed experimentally by setting the irradiation time of the light to 3 hours, but the irradiation time of the light is not limited to 3 hours or less. The irradiation time of the light may also include modification and extension beyond the aforementioned range.

In the irradiating of the oxygen-saturated mixed solution with the light to produce the hydrogen peroxide,
it may include irradiating light having an irradiance of 10 to 1000 W/m². Specifically, the irradiance may be different depending on the type of light source for irradiating the organic working solution with light. In the case of light irradiation using the simulated sunlight source, light having an irradiance of 900 to 1000 W/m² may be irradiated. In the case of light irradiation using a short wavelength lamp, light having an irradiance of 10 W/m² to 100 W/m² may be irradiated.

The following shows Examples and Comparative Examples of an organic working solution and a method for producing hydrogen peroxide by photo-autoxidation utilizing the organic working solution.

### (Example 1-1) Production of Hydrogen Peroxide by Photo-Autoxidation Utilizing Organic Working Solution (Molar Ratio of Added Water to Aromatic Alcohol: 0 Mol %)

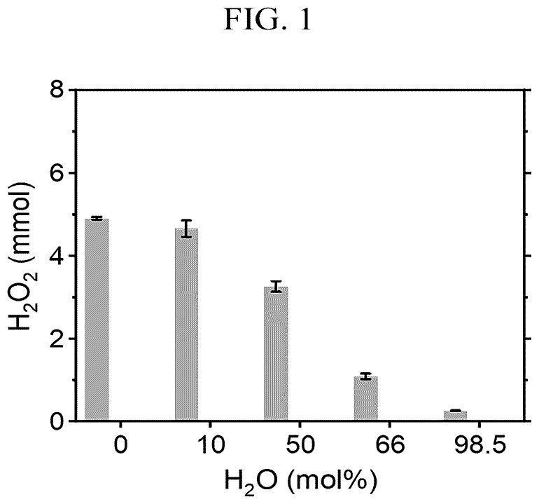

Benzyl alcohol (BzOH) as an aromatic alcohol and acetonitrile as an organic solvent were mixed in a volume ratio of 50:50 to prepare 30 ml of an organic working solution, which was then introduced into a solar reactor. Then, oxygen (O₂) gas was injected into the solar reactor for 30 minutes to perform an aeration process on the organic working solution. The organic working solution saturated with oxygen gas was irradiated with a simulated solar (AM 1.5G) at an intensity of 1000 W/m² for 3 hours to cause a photo-autoxidation reaction. The solar simulator used in the simulated solar irradiation was a US ABET technologies, Sun 3000 Class AAA model, and a product equipped with a 300 W DC xenon arc lamp was used. According to FIG. 1, 4.905 mmol of hydrogen peroxide was produced by the process of Example 1-1.

### (Example 1-2) Production of Hydrogen Peroxide by Photo-Autoxidation Utilizing Organic Working Solution (Molar Ratio of Added Water to Aromatic Alcohol: 10 Mol %)

Hydrogen peroxide was prepared by the same process as in Example 1-1, except that water was added at a molar ratio of 10 mol % to the total number of moles of the aromatic alcohol after the mixing of the aromatic alcohol and the organic solvent and introducing the mixture into the solar reactor. According to FIG. 1, 4.656 mmol of hydrogen peroxide was produced by the process of Example 1-2.

### (Example 1-3) Production of Hydrogen Peroxide by Photo-Autoxidation Utilizing Organic Working Solution (Molar Ratio of Added Water to Aromatic Alcohol: 50 Mol %)

Hydrogen peroxide was prepared by the same process as in Example 1-1, except that water was added at a molar ratio of 50 mol % to the total number of moles of the aromatic alcohol after the mixing of the aromatic alcohol and the organic solvent and introducing the mixture into the solar reactor. According to FIG. 1, 3.259 mmol of hydrogen peroxide was produced by the process of Example 1-3.

### (Example 1-4) Production of Hydrogen Peroxide by Photo-Autoxidation Utilizing Organic Working Solution (Molar Ratio of Added Water to Aromatic Alcohol: 66 Mol %)

Hydrogen peroxide was prepared by the same process as in Example 1-1, except that water was added at a molar ratio of 66 mol % to the total number of moles of the aromatic alcohol after the mixing of the aromatic alcohol and the organic solvent and introducing the mixture into the solar reactor. According to FIG. 1, 1.087 mmol of hydrogen peroxide was produced by the process of Example 1-4.

### (Example 1-5) Production of Hydrogen Peroxide by Photo-Autoxidation Utilizing Organic Working Solution (Molar Ratio of Added Water to Aromatic Alcohol: 98.5 Mol %)

Hydrogen peroxide was prepared by the same process as in Example 1-1, except that water was added at a molar ratio of 98.5 mol % to the total number of moles of the aromatic alcohol after the mixing of the aromatic alcohol and the organic solvent and introducing the mixture into the solar reactor. According to FIG. 1, 0.250 mmol of hydrogen peroxide was produced by the process of Example 1-5.

### (Example 2-1) Production of Hydrogen Peroxide by Photo-Autoxidation Utilizing Organic Working Solution Depending on Aromatic Alcohol Type (Aromatic Alcohol Type: Benzyl Alcohol (BzOH))

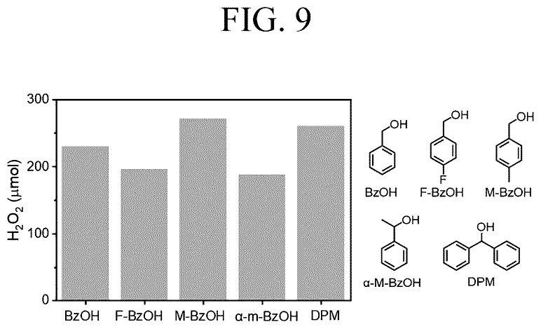

5 mmol of benzyl alcohol (BzOH) as an aromatic alcohol and 5 ml of dimethyl sulfoxide (DMSO) as an organic solvent were mixed to prepare an organic working solution, which was then introduced into a solar reactor. Then, oxygen (O₂) gas was injected into the solar reactor for 30 minutes to perform an aeration process on the organic working solution. The organic working solution saturated with oxygen gas was irradiated with simulated solar (AM 1.5G) at an intensity of 990 W/m² to cause a photo-autoxidation reaction. According to FIG. 9, 229.8 μmol of hydrogen peroxide was produced by the process of Example 2-1.

### (Example 2-2) Production of Hydrogen Peroxide by Photo-Autoxidation Utilizing Organic Working Solution Depending on Aromatic Alcohol Type (Aromatic Alcohol Type: 4-Fluorobenzyl Alcohol (F-BzOH))

Hydrogen peroxide was prepared in the same manner as in Example 2-1, except that an organic working solution was produced by mixing 4-fluorobenzyl alcohol (F-BzOH) instead of benzyl alcohol (BzOH) as the aromatic alcohol. According to FIG. 9, 196.3 μmol of hydrogen peroxide was produced by the process of Example 2-2.

### (Example 2-3) Production of Hydrogen Peroxide by Photo-Autoxidation Utilizing Organic Working Solution Depending on Aromatic Alcohol Type (Aromatic Alcohol Type: 4-Methylbenzyl Alcohol (M-BzOH))

Hydrogen peroxide was prepared in the same manner as in Example 2-1, except that an organic working solution was produced by mixing 4-methylbenzyl alcohol (M-BzOH) instead of benzyl alcohol (BzOH) as the aromatic alcohol. According to FIG. 9, 271.5 μmol of hydrogen peroxide was produced by the process of Example 2-3.

### (Example 2-4) Production of Hydrogen Peroxide by Photo-Autoxidation Utilizing Organic Working Solution Depending on Aromatic Alcohol Type (Aromatic Alcohol Type: α-Methylbenzyl Alcohol (α-m-BzOH))

Hydrogen peroxide was prepared in the same manner as in Example 2-1, except that an organic working solution was produced by mixing α-methylbenzyl alcohol (α-m-BzOH) instead of benzyl alcohol (BzOH) as the aromatic alcohol. According to FIG. 9, 188.3 μmol of hydrogen peroxide was produced by the process of Example 2-4.

### (Example 2-5) Production of Hydrogen Peroxide by Photo-Autoxidation Utilizing Organic Working Solution Depending on Aromatic Alcohol Type (Aromatic Alcohol Type: Diphenylmethanol (DPM))

Hydrogen peroxide was prepared in the same manner as in Example 2-1, except that an organic working solution was produced by mixing diphenylmethanol (DPM) instead of benzyl alcohol (BzOH) as the aromatic alcohol. According to FIG. 9, 260.7 μmol of hydrogen peroxide was produced by the process of Example 2-5.

### (Example 3-1) Production of Hydrogen Peroxide by Photo-Autoxidation Utilizing Organic Working Solution Depending on Volume Ratio of Aromatic Alcohol (Benzyl Alcohol, BzOH) and Organic Solvent (Acetonitrile) (Aromatic Alcohol:Organic Solvent=10:90 Volume Ratio)

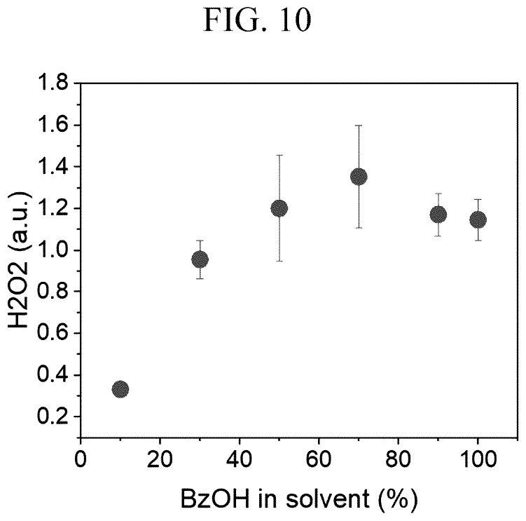

Hydrogen peroxide was produced in the same process as in Example 1-1, except that benzyl alcohol (BzOH) and acetonitrile were mixed in a volume ratio of 10:90 and irradiated with light of a 365 nm UV lamp for 10 minutes in the preparing of 30 ml of the organic working solution by mixing the aromatic alcohol and the organic solvent. According to FIG. 10, a photochemical hydrogen peroxide production efficiency of the organic working solution by the process of Example 3-1 was derived as 0.331 a.u. as a light absorption value.

### (Example 3-2) Production of Hydrogen Peroxide by Photo-Autoxidation Utilizing Organic Working Solution Depending on Volume Ratio of Aromatic Alcohol (Benzyl Alcohol, BzOH) and Organic Solvent (Acetonitrile) (Aromatic Alcohol:Organic Solvent=30:70 Volume Ratio)

Hydrogen peroxide was produced in the same process as in Example 3-1, except that benzyl alcohol (BzOH) and acetonitrile were mixed in a volume ratio of 30:70 in the preparing of 30 ml of the organic working solution by mixing the aromatic alcohol and the organic solvent. According to FIG. 10, a photochemical hydrogen peroxide production efficiency of the organic working solution by the process of Example 3-2 was derived as 0.956 a.u. as a light absorption value.

### (Example 3-3) Production of Hydrogen Peroxide by Photo-Autoxidation Utilizing Organic Working Solution Depending on Volume Ratio of Aromatic Alcohol (Benzyl Alcohol, BzOH) and Organic Solvent (Acetonitrile) (Aromatic Alcohol:Organic Solvent=50:50 Volume Ratio)

Hydrogen peroxide was produced in the same process as in Example 3-1, except that benzyl alcohol (BzOH) and acetonitrile were mixed in a volume ratio of 50:50 in the preparing of 30 ml of the organic working solution by mixing the aromatic alcohol and the organic solvent. According to FIG. 10, a photochemical hydrogen peroxide production efficiency of the organic working solution by the process of Example 3-3 was derived as 1.201 a.u. as a light absorption value.

### (Example 3-4) Production of Hydrogen Peroxide by Photo-Autoxidation Utilizing Organic Working Solution Depending on Volume Ratio of Aromatic Alcohol (Benzyl Alcohol, BzOH) and Organic Solvent (Acetonitrile) (Aromatic Alcohol:Organic Solvent=70:30 Volume Ratio)

Hydrogen peroxide was produced in the same process as in Example 3-1, except that benzyl alcohol (BzOH) and acetonitrile were mixed in a volume ratio of 70:30 in the preparing of 30 ml of the organic working solution by mixing the aromatic alcohol and the organic solvent. According to FIG. 10, a photochemical hydrogen peroxide production efficiency of the organic working solution by the process of Example 3-4 was derived as 1.353 a.u. as a light absorption value.

### (Example 3-5) Production of Hydrogen Peroxide by Photo-Autoxidation Utilizing Organic Working Solution Depending on Volume Ratio of Aromatic Alcohol (Benzyl Alcohol, BzOH) and Organic Solvent (Acetonitrile) (Aromatic Alcohol:Organic Solvent=90:10 Volume Ratio)

Hydrogen peroxide was produced in the same process as in Example 3-1, except that benzyl alcohol (BzOH) and acetonitrile were mixed in a volume ratio of 90:10 in the preparing of 30 ml of the organic working solution by mixing the aromatic alcohol and the organic solvent. According to FIG. 10, a photochemical hydrogen peroxide production efficiency of the organic working solution by the process of Example 3-5 was derived as 1.171 a.u. as a light absorption value.

### (Example 3-6) Production of Hydrogen Peroxide by Photo-Autoxidation Utilizing Organic Working Solution Depending on Volume Ratio of Aromatic Alcohol (Benzyl Alcohol, BzOH) and Organic Solvent (Acetonitrile) (Aromatic Alcohol:Organic Solvent=100:0 Volume Ratio)

Hydrogen peroxide was produced in the same process as in Example 3-1, except that benzyl alcohol (BzOH) and acetonitrile were prepared in a volume ratio of 100:0 in the preparing of 30 ml of the organic working solution by mixing the aromatic alcohol and the organic solvent. According to FIG. 10, a photochemical hydrogen peroxide production efficiency of the organic working solution by the process of Example 3-6 was derived as 1.146 a.u. as a light absorption value.

### (Example 3-7) Production of Hydrogen Peroxide by Photo-Autoxidation Utilizing Organic Working Solution Depending on Volume Ratio of Aromatic Alcohol (α-Methylbenzyl Alcohol, α-m-BzOH) and Organic Solvent (Acetonitrile) (Aromatic Alcohol:Organic Solvent=10:90 Volume Ratio)

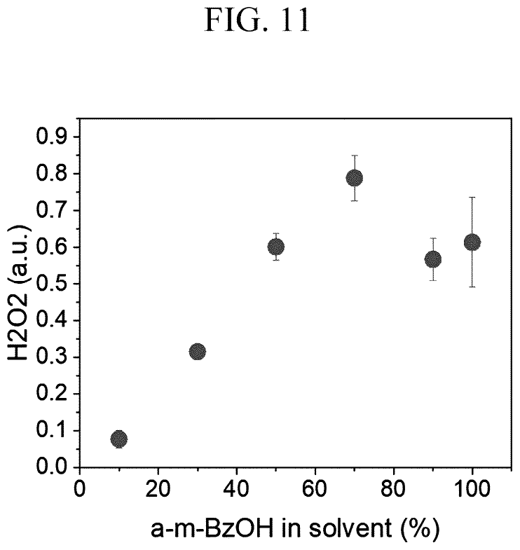

Hydrogen peroxide was produced in the same process as in Example 3-1, except that α-methylbenzyl alcohol (α-m-BzOH) and acetonitrile were mixed in a volume ratio of 10:90 in the preparing of 30 ml of the organic working solution by mixing the aromatic alcohol and the organic solvent. According to FIG. 11, a photochemical hydrogen peroxide production efficiency of the organic working solution by the process of Example 3-7 was derived as 0.077 a.u. as a light absorption value.

### (Example 3-8) Production of Hydrogen Peroxide by Photo-Autoxidation Utilizing Organic Working Solution Depending on Volume Ratio of Aromatic Alcohol (α-Methylbenzyl Alcohol, α-m-BzOH) and Organic Solvent (Acetonitrile) (Aromatic Alcohol:Organic Solvent=30:70 Volume Ratio)

Hydrogen peroxide was produced in the same process as in Example 3-1, except that α-methylbenzyl alcohol (α-m-BzOH) and acetonitrile were mixed in a volume ratio of 30:70 in the preparing of 30 ml of the organic working solution by mixing the aromatic alcohol and the organic solvent. According to FIG. 11, a photochemical hydrogen peroxide production efficiency of the organic working solution by the process of Example 3-8 was derived as 0.315 a.u. as a light absorption value.

### (Example 3-9) Production of Hydrogen Peroxide by Photo-Autoxidation Utilizing Organic Working Solution Depending on Volume Ratio of Aromatic Alcohol (α-Methylbenzyl Alcohol, α-m-BzOH) and Organic Solvent (Acetonitrile) (Aromatic Alcohol:Organic Solvent=50:50 Volume Ratio)

Hydrogen peroxide was produced in the same process as in Example 3-1, except that α-methylbenzyl alcohol (α-m-BzOH) and acetonitrile were mixed in a volume ratio of 50:50 in the preparing of 30 ml of the organic working solution by mixing the aromatic alcohol and the organic solvent. According to FIG. 11, a photochemical hydrogen peroxide production efficiency of the organic working solution by the process of Example 3-9 was derived as 0.601 a.u. as a light absorption value.

### (Example 3-10) Production of Hydrogen Peroxide by Photo-Autoxidation Utilizing Organic Working Solution Depending on Volume Ratio of Aromatic Alcohol (α-Methylbenzyl Alcohol, α-m-BzOH) and Organic Solvent (Acetonitrile) (Aromatic Alcohol:Organic Solvent=70:30 Volume Ratio)

Hydrogen peroxide was produced in the same process as in Example 3-1, except that α-methylbenzyl alcohol (α-m-BzOH) and acetonitrile were mixed in a volume ratio of 70:30 in the preparing of 30 ml of the organic working solution by mixing the aromatic alcohol and the organic solvent. According to FIG. 11, a photochemical hydrogen peroxide production efficiency of the organic working solution by the process of Example 3-10 was derived as 0.788 a.u. as a light absorption value.

### (Example 3-11) Production of Hydrogen Peroxide by Photo-Autoxidation Utilizing Organic Working Solution Depending on Volume Ratio of Aromatic Alcohol (α-Methylbenzyl Alcohol, α-m-BzOH) and Organic Solvent (Acetonitrile) (Aromatic Alcohol:Organic Solvent=90:10 Volume Ratio)

Hydrogen peroxide was produced in the same process as in Example 3-1, except that α-methylbenzyl alcohol (α-m-BzOH) and acetonitrile were mixed in a volume ratio of 90:10 in the preparing of 30 ml of the organic working solution by mixing the aromatic alcohol and the organic solvent. According to FIG. 11, a photochemical hydrogen peroxide production efficiency of the organic working solution by the process of Example 3-11 was derived as 0.567 a.u. as a light absorption value.

### (Example 3-12) Production of Hydrogen Peroxide by Photo-Autoxidation Utilizing Organic Working Solution Depending on Volume Ratio of Aromatic Alcohol (α-Methylbenzyl Alcohol, α-m-BzOH) and Organic Solvent (Acetonitrile) (Aromatic Alcohol:Organic Solvent=100:0 Volume Ratio)

Hydrogen peroxide was produced in the same process as in Example 3-1, except that α-methylbenzyl alcohol (α-m-BzOH) and acetonitrile were mixed in a volume ratio of 100:0 in the preparing of 30 ml of the organic working solution by mixing the aromatic alcohol and the organic solvent. According to FIG. 11, a photochemical hydrogen peroxide production efficiency of the organic working solution by the process of Example 3-12 was derived as 0.613 a.u. as a light absorption value.

### (Example 4-1) Production of Hydrogen Peroxide by Photo-Autoxidation Utilizing Organic Working Solution Depending on Organic Solvent Type (Organic Solvent Type: Methanol)

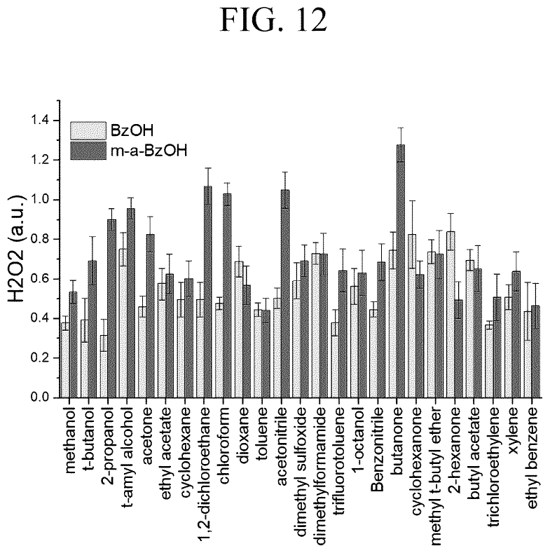

Hydrogen peroxide was produced in the same process as in Example 1-1, except that benzyl alcohol (BzOH) and methanol were mixed in a volume ratio of 70:30 and irradiated with light of a 365 nm UV lamp for 5 minutes in the preparing of 30 ml of the organic working solution by mixing the aromatic alcohol and the organic solvent. According to FIG. 12, a photochemical hydrogen peroxide production efficiency of the organic working solution by the process of Example 4-1 was derived as 0.376 a.u. as a light absorption value.

### (Example 4-2) Production of Hydrogen Peroxide by Photo-Autoxidation Utilizing Organic Working Solution Depending on Organic Solvent Type (Organic Solvent Type: t-Butanol)

Hydrogen peroxide was produced in the same process as in Example 4-1, except that t-butanol was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-2 was derived as 0.391 a.u. as a light absorption value.

### (Example 4-3) Production of Hydrogen Peroxide by Photo-Autoxidation Utilizing Organic Working Solution Depending on Organic Solvent Type (Organic Solvent Type: 2-Propanol)

Hydrogen peroxide was produced in the same process as in Example 4-1, except that 2-propanol was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-3 was derived as 0.315 a.u. as a light absorption value.

### (Example 4-4) Production of Hydrogen Peroxide by Photo-Autoxidation Utilizing Organic Working Solution Depending on Organic Solvent Type (Organic Solvent Type: t-Amyl Alcohol)

Hydrogen peroxide was produced in the same process as in Example 4-1, except that t-amyl alcohol was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-4 was derived as 0.75 a.u. as a light absorption value.

### (Example 4-5) Production of Hydrogen Peroxide by Photo-Autoxidation Utilizing Organic Working Solution Depending on Organic Solvent Type (Organic Solvent Type: Acetone)

Hydrogen peroxide was produced in the same process as in Example 4-1, except that acetone was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-5 was derived as 0.459 a.u. as a light absorption value.

### (Example 4-6) Production of Hydrogen Peroxide by Photo-Autoxidation Utilizing Organic Working Solution Depending on Organic Solvent Type (Organic Solvent Type: Ethyl Acetate)

Hydrogen peroxide was produced in the same process as in Example 4-1, except that ethyl acetate was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-6 was derived as 0.574 a.u. as a light absorption value.

### (Example 4-7) Production of Hydrogen Peroxide by Photo-Autoxidation Utilizing Organic Working Solution Depending on Organic Solvent Type (Organic Solvent Type: Cyclohexane)

Hydrogen peroxide was produced in the same process as in Example 4-1, except that cyclohexane was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-7 was derived as 0.495 a.u. as a light absorption value.

### (Example 4-8) Production of Hydrogen Peroxide by Photo-Autoxidation Utilizing Organic Working Solution Depending on Organic Solvent Type (Organic Solvent Type: 1,2-Dichloroethane)

Hydrogen peroxide was produced in the same process as in Example 4-1, except that 1,2-dichloroethane was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-8 was derived as 0.495 a.u. as a light absorption value.

### (Example 4-9) Production of Hydrogen Peroxide by Photo-Autoxidation Utilizing Organic Working Solution Depending on Organic Solvent Type (Organic Solvent Type: Chloroform)

Hydrogen peroxide was produced in the same process as in Example 4-1, except that chloroform was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-9 was derived as 0.475 a.u. as a light absorption value.

### (Example 4-10) Production of Hydrogen Peroxide by Photo-Autoxidation Utilizing Organic Working Solution Depending on Organic Solvent Type (Organic Solvent Type: Dioxane)

Hydrogen peroxide was produced in the same process as in Example 4-1, except that dioxane was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-10 was derived as 0.688 a.u. as a light absorption value.

### (Example 4-11) Production of Hydrogen Peroxide by Photo-Autoxidation Utilizing Organic Working Solution Depending on Organic Solvent Type (Organic Solvent Type: Toluene)

Hydrogen peroxide was produced in the same process as in Example 4-1, except that toluene was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-11 was derived as 0.444 a.u. as a light absorption value.

### (Example 4-12) Production of Hydrogen Peroxide by Photo-Autoxidation Utilizing Organic Working Solution Depending on Organic Solvent Type (Organic Solvent Type: Acetonitrile)

Hydrogen peroxide was produced in the same process as in Example 4-1, except that acetonitrile was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-12 was derived as 0.501 a.u. as a light absorption value.

### (Example 4-13) Production of Hydrogen Peroxide by Photo-Autoxidation Utilizing Organic Working Solution Depending on Organic Solvent Type (Organic Solvent Type: Dimethyl Sulfoxide, DMSO)

Hydrogen peroxide was produced in the same process as in Example 4-1, except that dimethyl sulfoxide was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-13 was derived as 0.589 a.u. as a light absorption value.

### (Example 4-14) Production of Hydrogen Peroxide by Photo-Autoxidation Utilizing Organic Working Solution Depending on Organic Solvent Type (Organic Solvent Type: Dimethylformamide, DMF)

Hydrogen peroxide was produced in the same process as in Example 4-1, except that dimethylformamide was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-14 was derived as 0.728 a.u. as a light absorption value.

### (Example 4-15) Production of Hydrogen Peroxide by Photo-Autoxidation Utilizing Organic Working Solution Depending on Organic Solvent Type (Organic Solvent Type: Trifluorotoluene (TFT))

Hydrogen peroxide was produced in the same process as in Example 4-1, except that trifluorotoluene was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-15 was derived as 0.377 a.u. as a light absorption value.

### (Example 4-16) Production of Hydrogen Peroxide by Photo-Autoxidation Utilizing Organic Working Solution Depending on Organic Solvent Type (Organic Solvent Type: 1-Octanol)

Hydrogen peroxide was produced in the same process as in Example 4-1, except that 1-octanol was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-16 was derived as 0.562 a.u. as a light absorption value.

### (Example 4-17) Production of Hydrogen Peroxide by Photo-Autoxidation Utilizing Organic Working Solution Depending on Organic Solvent Type (Organic Solvent Type: Benzonitrile)

Hydrogen peroxide was produced in the same process as in Example 4-1, except that benzonitrile was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-17 was derived as 0.444 a.u. as a light absorption value.

### (Example 4-18) Production of Hydrogen Peroxide by Photo-Autoxidation Utilizing Organic Working Solution Depending on Organic Solvent Type (Organic Solvent Type: Butanone)

Hydrogen peroxide was produced in the same process as in Example 4-1, except that butanone was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-18 was derived as 0.744 a.u. as a light absorption value.

### (Example 4-19) Production of Hydrogen Peroxide by Photo-Autoxidation Utilizing Organic Working Solution Depending on Organic Solvent Type (Organic Solvent Type: Cyclohexanone)

Hydrogen peroxide was produced in the same process as in Example 4-1, except that cyclohexanone was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-19 was derived as 0.825 a.u. as a light absorption value.

### (Example 4-20) Production of Hydrogen Peroxide by Photo-Autoxidation Utilizing Organic Working Solution Depending on Organic Solvent Type (Organic Solvent Type: Methyl Tert-Butyl Ether)

Hydrogen peroxide was produced in the same process as in Example 4-1, except that methyl tert-butyl ether was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-20 was derived as 0.736 a.u. as a light absorption value.

### (Example 4-21) Production of Hydrogen Peroxide by Photo-Autoxidation Utilizing Organic Working Solution Depending on Organic Solvent Type (Organic Solvent Type: 2-Hexanone)

Hydrogen peroxide was produced in the same process as in Example 4-1, except that 2-hexanone was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-21 was derived as 0.839 a.u. as a light absorption value.

### (Example 4-22) Production of Hydrogen Peroxide by Photo-Autoxidation Utilizing Organic Working Solution Depending on Organic Solvent Type (Organic Solvent Type: Butyl Acetate)

Hydrogen peroxide was produced in the same process as in Example 4-1, except that butyl acetate was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-22 was derived as 0.694 a.u. as a light absorption value.

### (Example 4-23) Production of Hydrogen Peroxide by Photo-Autoxidation Utilizing Organic Working Solution Depending on Organic Solvent Type (Organic Solvent Type: Trichloroethylene)

Hydrogen peroxide was produced in the same process as in Example 4-1, except that trichloroethylene was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-23 was derived as 0.366 a.u. as a light absorption value.

### (Example 4-24) Production of Hydrogen Peroxide by Photo-Autoxidation Utilizing Organic Working Solution Depending on Organic Solvent Type (Organic Solvent Type: Xylene)

Hydrogen peroxide was produced in the same process as in Example 4-1, except that xylene was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-24 was derived as 0.506 a.u. as a light absorption value.

### (Example 4-25) Production of Hydrogen Peroxide by Photo-Autoxidation Utilizing Organic Working Solution Depending on Organic Solvent Type (Organic Solvent Type: Ethyl Benzene)

Hydrogen peroxide was produced in the same process as in Example 4-1, except that ethyl benzene was mixed instead of methanol as an organic solvent in the preparing of 30 ml of the organic working solution by mixing the aromatic alcohol and the organic solvent. According to FIG. 12, a photochemical hydrogen peroxide production efficiency of the organic working solution by the process of Example 4-25 was derived as 0.435 a.u. as a light absorption value.

### (Example 5-1) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: Benzyl Alcohol/Amount of Benzaldehyde Added: 0% by Volume)

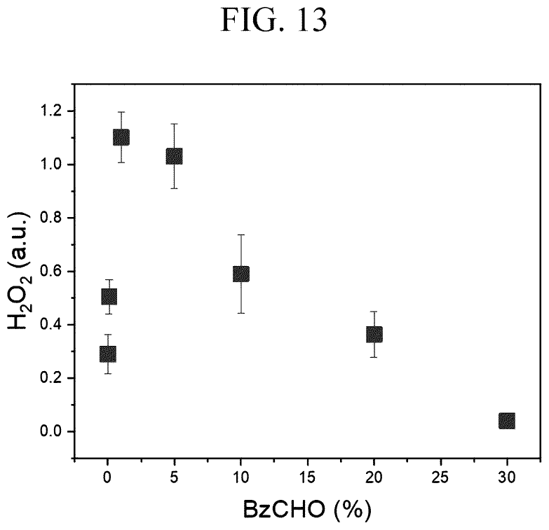

Hydrogen peroxide was produced in the same process as in Example 1-1, except that 30 ml of the organic working solution was irradiated with light of a 365 nm UV lamp for 5 minutes in the introducing of 30 ml of the organic working solution prepared by mixing the aromatic alcohol and the organic solvent into the solar reactor. According to FIG. 13, a photochemical hydrogen peroxide production efficiency of the organic working solution by the process of Example 5-1 was derived as 0.29 a.u. as a light absorption value.

### (Example 5-2) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: Benzyl Alcohol/Amount of Benzaldehyde Added: 0.1% by Volume)

Hydrogen peroxide was produced in the same process as in Example 5-1, except that 0.1% by volume of benzaldehyde, which is an aromatic carbonyl compound, was additionally mixed, based on 30 ml of the organic working solution in the introducing of 30 ml of the organic working solution prepared by mixing the aromatic alcohol and the organic solvent into the solar reactor. According to FIG. 13, a photochemical hydrogen peroxide production efficiency of the organic working solution by the process of Example 5-2 was derived as 0.504 a.u. as a light absorption value.

### (Example 5-3) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: Benzyl Alcohol/Amount of Benzaldehyde Added: 1% by Volume)

Hydrogen peroxide was produced in the same process as in Example 5-1, except that 1% by volume of benzaldehyde, which is an aromatic carbonyl compound, was additionally mixed, based on 30 ml of the organic working solution in the introducing of 30 ml of the organic working solution prepared by mixing the aromatic alcohol and the organic solvent into the solar reactor. According to FIG. 13, a photochemical hydrogen peroxide production efficiency of the organic working solution by the process of Example 5-3 was derived as 1.102 a.u. as a light absorption value.

### (Example 5-4) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: Benzyl Alcohol/Amount of Benzaldehyde Added: 5% by Volume)

Hydrogen peroxide was produced in the same process as in Example 5-1, except that 5% by volume of benzaldehyde, which is an aromatic carbonyl compound, was additionally mixed, based on 30 ml of the organic working solution in the introducing of 30 ml of the organic working solution prepared by mixing the aromatic alcohol and the organic solvent into the solar reactor. According to FIG. 13, a photochemical hydrogen peroxide production efficiency of the organic working solution by the process of Example 5-4 was derived as 1.031 a.u. as a light absorption value.

### (Example 5-5) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: Benzyl Alcohol/Amount of Benzaldehyde Added: 10% by Volume)

Hydrogen peroxide was produced in the same process as in Example 5-1, except that 10% by volume of benzaldehyde, which is an aromatic carbonyl compound, was additionally mixed, based on 30 ml of the organic working solution in the introducing of 30 ml of the organic working solution prepared by mixing the aromatic alcohol and the organic solvent into the solar reactor.

According to FIG. 13, the photochemical hydrogen peroxide production efficiency of the organic reaction solution by the process of the example embodiment 5-5 was derived as 0.59 a.u. as the light absorption value.

### (Example 5-6) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: Benzyl Alcohol/Amount of Benzaldehyde Added: 20% by Volume)

Hydrogen peroxide was produced in the same process as in Example 5-1, except that 20% by volume of benzaldehyde, which is an aromatic carbonyl compound, was additionally mixed, based on 30 ml of the organic working solution in the introducing of 30 ml of the organic working solution prepared by mixing the aromatic alcohol and the organic solvent into the solar reactor. According to FIG. 13, a photochemical hydrogen peroxide production efficiency of the organic working solution by the process of Example 5-6 was derived as 0.364 a.u. as a light absorption value.

### (Example 5-7) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: Benzyl Alcohol/Amount of Benzaldehyde Added: 30% by Volume)

Hydrogen peroxide was produced in the same process as in Example 5-1, except that 30% by volume of benzaldehyde, which is an aromatic carbonyl compound, was additionally mixed, based on 30 ml of the organic working solution in the introducing of 30 ml of the organic working solution prepared by mixing the aromatic alcohol and the organic solvent into the solar reactor. According to FIG. 13, a photochemical hydrogen peroxide production efficiency of the organic working solution by the process of Example 5-7 was derived as 0.04 a.u. as a light absorption value.

### (Example 5-8) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: α-Methylbenzyl Alcohol/Amount of Benzaldehyde Added: 0% by Volume)

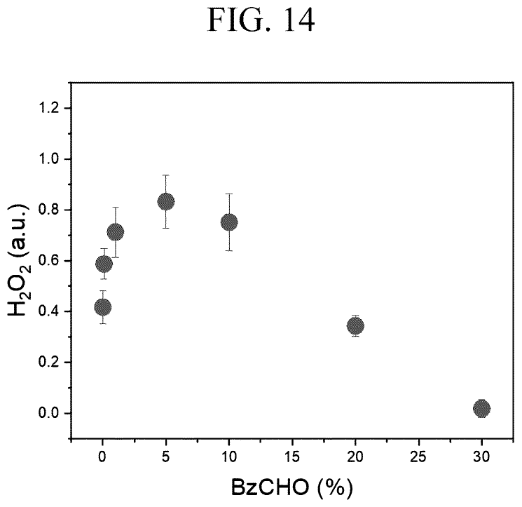

Hydrogen peroxide was produced in the same process as in Example 5-1, except that α-methylbenzyl alcohol was added instead of benzyl alcohol in the introducing of 30 ml of the organic working solution prepared by mixing the aromatic alcohol and the organic solvent into the solar reactor. According to FIG. 14, a photochemical hydrogen peroxide production efficiency of the organic working solution by the process of Example 5-8 was derived as 0.417 a.u. as a light absorption value.

### (Example 5-9) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: α-Methylbenzyl Alcohol/Amount of Benzaldehyde Added: 0.1% by Volume)

Hydrogen peroxide was produced in the same process as in Example 5-2, except that α-methylbenzyl alcohol was added instead of benzyl alcohol in the introducing of 30 ml of the organic working solution prepared by mixing the aromatic alcohol and the organic solvent into the solar reactor. According to FIG. 14, a photochemical hydrogen peroxide production efficiency of the organic working solution by the process of Example 5-9 was derived as 0.588 a.u. as a light absorption value.

### (Example 5-10) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: α-Methylbenzyl Alcohol/Amount of Benzaldehyde Added: 1% by Volume)

Hydrogen peroxide was produced in the same process as in Example 5-3, except that α-methylbenzyl alcohol was added instead of benzyl alcohol in the introducing of 30 ml of the organic working solution prepared by mixing the aromatic alcohol and the organic solvent into the solar reactor. According to FIG. 14, a photochemical hydrogen peroxide production efficiency of the organic working solution by the process of Example 5-10 was derived as 0.713 a.u. as a light absorption value.

### (Example 5-11) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: α-Methylbenzyl Alcohol/Amount of Benzaldehyde Added: 5% by Volume)

Hydrogen peroxide was produced in the same process as in Example 5-4, except that α-methylbenzyl alcohol was added instead of benzyl alcohol in the introducing of 30 ml of the organic working solution prepared by mixing the aromatic alcohol and the organic solvent into the solar reactor. According to FIG. 14, a photochemical hydrogen peroxide production efficiency of the organic working solution by the process of Example 5-11 was derived as 0.833 a.u. as a light absorption value.

### (Example 5-12) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: α-Methylbenzyl Alcohol/Amount of Benzaldehyde Added: 10% by Volume)

Hydrogen peroxide was produced in the same process as in Example 5-5, except that α-methylbenzyl alcohol was added instead of benzyl alcohol in the introducing of 30 ml of the organic working solution prepared by mixing the aromatic alcohol and the organic solvent into the solar reactor. According to FIG. 14, a photochemical hydrogen peroxide production efficiency of the organic working solution by the process of Example 5-12 was derived as 0.752 a.u. as a light absorption value.

### (Example 5-13) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: α-Methylbenzyl Alcohol/Amount of Benzaldehyde Added: 20% by Volume)

Hydrogen peroxide was produced in the same process as in Example 5-6, except that α-methylbenzyl alcohol was added instead of benzyl alcohol in the introducing of 30 ml of the organic working solution prepared by mixing the aromatic alcohol and the organic solvent into the solar reactor. According to FIG. 14, a photochemical hydrogen peroxide production efficiency of the organic working solution by the process of Example 5-13 was derived as 0.343 a.u. as a light absorption value.

### (Example 5-14) Production of Hydrogen Peroxide by Photo-Autoxidation Utilizing Organic Working Solution Depending on Volume Ratio (Vol %) of Benzaldehyde, which is Aromatic Carbonyl Compound, Added to Organic Working Solution (Hydrogen Donor: α-Methylbenzyl Alcohol/Amount of Benzaldehyde Added: 30% by Volume)

Hydrogen peroxide was produced in the same process as in Example 5-7, except that α-methylbenzyl alcohol was added instead of benzyl alcohol in the introducing of 30 ml of the organic working solution prepared by mixing the aromatic alcohol and the organic solvent into the solar reactor. According to FIG. 14, a photochemical hydrogen peroxide production efficiency of the organic working solution by the process of Example 5-14 was derived as 0.019 a.u. as a light absorption value.

### (Comparative Example 1-1) Production of Hydrogen Peroxide by Photo-Autoxidation Utilizing Organic Working Solution Depending on Light Wavelength Region (Light Wavelength Region: Long-Wavelength Ultraviolet in the Range of 315-400 nm)

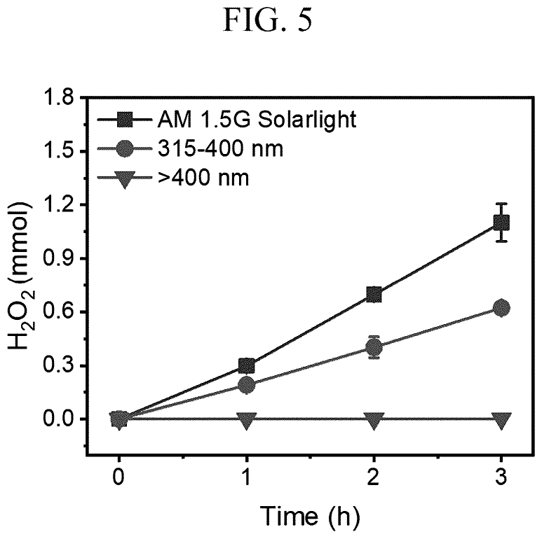

Hydrogen peroxide was produced in the same process as in Example 1-1, except that the organic working solution saturated with oxygen gas was irradiated with long-wavelength ultraviolet having a light wavelength range of 315 nm to 400 nm instead of a simulated solar (AM 1.5G). According to FIG. 5, 0.621 mmol of hydrogen peroxide was produced by the process of Comparative Example 1-1.

### (Comparative Example 1-2) Production of Hydrogen Peroxide by Photo-Autoxidation Utilizing Organic Working Solution Depending on Light Wavelength Region (Light Wavelength Region: Visible Light in the Range Greater than 400 nm)

Hydrogen peroxide was produced in the same process as in Example 1-1, except that the organic working solution saturated with oxygen gas was irradiated with visible light having a light wavelength range greater than 400 nm instead of a simulated solar (AM 1.5G). According to FIG. 5, 0.002 mmol of hydrogen peroxide was produced by the process of Comparative Example 1-1.

The following is an experimental example for confirming production ability of a hydrogen peroxide producing process according to an embodiment of the present invention and a hydrogen peroxide production mechanism.

### (Experimental Example 1) Production Amount Analysis of Hydrogen Peroxide

The production amount of hydrogen peroxide prepared according to Examples 1-1 to 1-5 was compared and analyzed.

Specifically, about 1 ml of the sample solution was obtained per hour after exposure to solar while stirring the organic working solution prepared according to the Example, and the production amount of hydrogen peroxide was measured. The production amount of hydrogen peroxide was measured by a colorimetric method using a titanium sulfate solution.

FIG. 1 and Table 1 showed the production amount of hydrogen peroxide relative to a mole ratio (mol %) of water added, based on the number of moles of benzyl alcohol (BzOH), which is an aromatic alcohol. According to FIG. 1 and Table 1, it can be confirmed that the production amount of hydrogen peroxide decreases as the amount of water added in the organic working solution increases.

### (Experimental Example 2) Production Amount Analysis of Benzaldehyde (BzCHO), which is Oxidized Organic Product

The production amounts of benzaldehydes (BzCHOs), which are oxidized organic products, prepared in Examples 1-1 to 1-5, were compared and analyzed.

Specifically, about 1 ml of the sample solution was obtained per hour after exposure to solar while stirring the organic working solution prepared according to the embodiment, and the production amount of benzaldehyde (BzCHO) was measured. The production amount of benzaldehyde was quantitatively analyzed using a gas chromatograph.

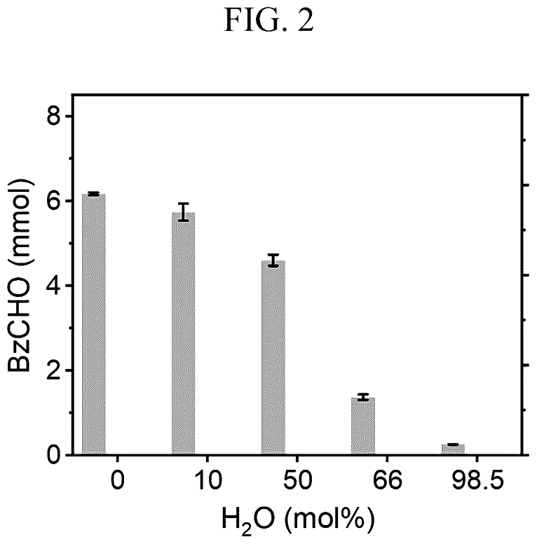

FIG. 2 and Table 1 showed the production amount of an oxidized organic product relative to a mole ratio (mol %) of added water based on the number of moles of benzyl alcohol (BzOH), which is an aromatic alcohol. According to FIG. 2 and Table 1, it can be confirmed that the production amount of benzaldehyde, which is an oxidized organic product, decreases as the amount of water added in the organic working solution increases.

### (Experimental Example 3) Solar-Chemical Conversion Efficiency of Hydrogen Peroxide Production Method (SCC Efficiency)

Solar-chemical conversion efficiency (SCC efficiency) of the hydrogen peroxide production methods according to Examples 1-1 to 1-5 was calculated.

Solar-chemical conversion efficiency (SCC efficiency) was calculated by the following Equation:

$$S C C efficiency ( \% ) =$$

$$\frac{[ Δ G for {H}_{2} {O}_{2} production ( J {mol}^{- 1} ) ] [ {H}_{2} {O}_{2} formed ( mol ) ]}{[ Total input power ( W ) ] [ Reaction time ( s ) ]} \times 100$$

wherein a free energy change of hydrogen peroxide was calculated as ΔG=117 kJ mol⁻¹, Power=solar irradiation intensity (980.88 W m⁻²)×irradiation area (0.007088 m²). The reaction time (seconds) was applied in terms of 3 hours. The solar-chemical conversion efficiency was derived when AM 1.5G simulated solar was used as a light source.

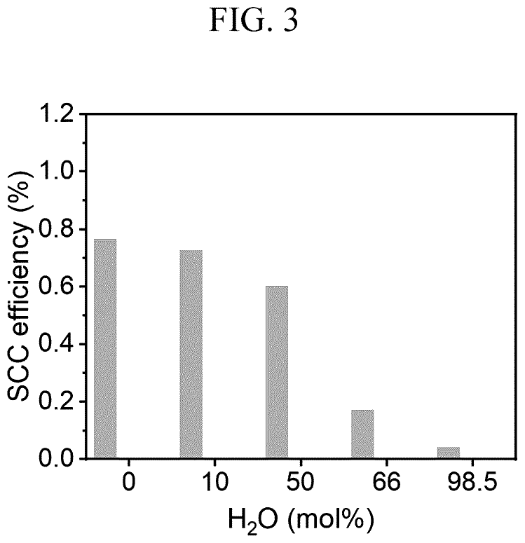

FIG. 3 and Table 1 showed the solar-chemical conversion efficiency (SCC efficiency) of the hydrogen peroxide production method relative to a mole ratio (mol %) of added water based on the number of moles of benzyl alcohol (BzOH), which is an aromatic alcohol.

According to FIG. 3 and Table 1, it can be confirmed that the solar-chemical conversion efficiency decreases as the amount of water added in the organic working solution increases.

### (Experimental Example 4) Production Efficiency of Hydrogen Peroxide and Oxidized Organic Product of Organic Working Solution Depending on Light Wavelength Region

The production efficiencies of the hydrogen peroxide and the benzaldehyde (BzCHO), which is an oxidized organic product, produced according to Example 1-1 and Comparative Examples 1-1 and 1-2 were compared and analyzed.

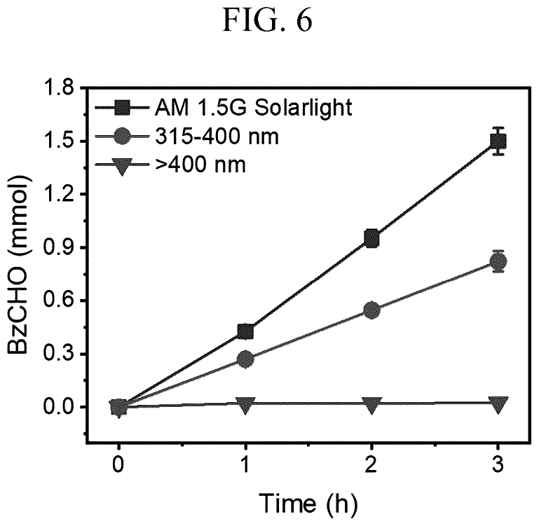

FIG. 5 and Table 1 showed the production amount of hydrogen peroxide depending on the wavelength region of light irradiated to the organic working solution. FIG. 6 and Table 1 showed the production amount of benzaldehyde (BzCHO) depending on the wavelength region of light irradiated to the organic working solution.

According to FIGS. 5, 6 and Table 1, when the simulated solar of AM 1.5G was irradiated, the production amount of hydrogen peroxide and benzaldehyde, which is oxidized organic product, was higher than when the light wavelengths in the range of 315 to 400 nm and greater than 400 nm were irradiated. In addition, when light in a range greater than 400 nm was irradiated, hydrogen peroxide and benzaldehyde were produced in a very small amount. From this, it can be confirmed that the organic working solution works optimally when it absorbs light in the ultraviolet and near-visible regions. These results can be inferred through the light absorption ranges of the aromatic alcohol and the aromatic carbonyl compound included the organic working solution. For example, benzyl alcohol absorbs light from about 280 nm to 300 nm, and benzaldehyde absorbs light from 380 nm to 400 nm. That is, considering that the light absorption wavelength range of benzaldehyde is 400 nm or less, photoexcitation of benzaldehyde is almost impossible at light of 400 nm or more, so it can be seen that hydrogen peroxide is hardly formed. In addition, the light absorption range may change within an error range of ±50 nm depending on the concentration of the aromatic alcohol and the aromatic carbonyl compound. Therefore, the light absorption range of the working solution and the production efficiency of hydrogen peroxide and oxidized organic products may vary depending on the ratio of the aromatic alcohol, the aromatic carbonyl compound, and the solvent constituting the organic working solution.

TABLE 1

| | | Organic working solution | | | | |
|---|---|---|---|---|---|---|
| | | Volume | | | Production | |
| | | ratio of | Amount | | amount of | Solar |
| | | Benzyl | of water | Production | oxidized | chemical |
| | | alcohol: | added to | amount of | organic | conversion |
| | Light | organic | aromatic | hydrogen | product | effeiciency |
| | irradiation | solvent | alcohol | peroxide | (B [symbol] CHO) | (SCC |
| Division | conditions | (v:v) | (mol %) | (mmol) | (mmol) | efficiency, %) |
| Example 1-1 | 1000 W/m² | 50:50 | 0 | 4.905 | 6.167 | 0.765 |
| Example 1-2 | Simulated solar | | 10 | 4.656 | 5.735 | 0.726 |
| Example 1-3 | (AM 1.5G) | | 50 | 3.259 | 4.601 | 0.602 |
| Example 1-4 | | | 66 | 1.087 | 1.358 | 0.170 |
| Example 1-5 | | | 98.5 | 0.250 | 0.250 | 0.039 |
| Comparative | 315-400 nm | | 0 | 0.621 | — | — |
| Example 1-1 | Long-wavelength | | | | | |
| | ultraviolet | | | | | |
| Comparative | Visible light | | 0 | 0.002 | — | — |
| Example 1-2 | above 400 nm | | | | | |

[symbol]

indicates data missing or illegible when filed

### (Experimental Example 5) Production Amount of Hydrogen Peroxide Depending on Aromatic Alcohol Type in Organic Working Solution

The production amounts of the hydrogen peroxides produced according to Examples 2-1 to 2-5 were analyzed.

As in Experimental Example 1, about 1 ml of the sample solution was obtained per hour after exposure to solar while stirring the organic working solution prepared according to the Example, and the production amount of hydrogen peroxide was measured. The production amount of hydrogen peroxide was measured by a colorimetric method using a titanium sulfate solution.

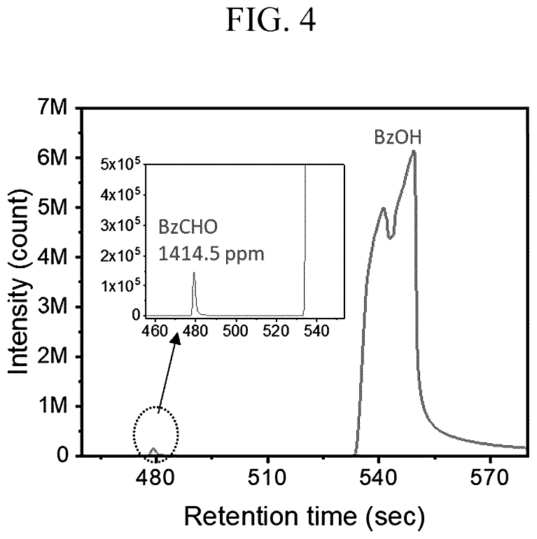

In Examples 2-1 to 2-5, an aromatic carbonyl compound was not separately added. According to FIG. 9 and Table 2, it can be confirmed that hydrogen peroxide is generated although there is a slight difference in the production amount of hydrogen peroxide depending on the aromatic alcohol type, even though the aromatic carbonyl compound is not added. This is a possible result because pure aromatic alcohol contains an aromatic carbonyl compound in which aromatic alcohol is partially oxidized. According to FIG. 4, it can be confirmed that a catalytic amount of benzaldehyde is included in the pure benzyl alcohol solution.

In addition, according to FIG. 9 and Table 2, it can be confirmed that when 4-methylbenzyl alcohol (M-BzOH) or diphenylmethanol (DPM) was applied as the aromatic alcohol, the production amount of hydrogen peroxide production was higher than that of benzyl alcohol. Specifically, performance may be improved in a case (M-BzOH) where benzyl alcohol is substituted with a methyl group having an electron-donating property as compared with a case (F-BzOH) where benzyl alcohol is substituted with a halogen element having an electron-withdrawing property. That is, an n,π* triplet electronic state in the form of a pseudo-radical formed by absorbing light and exciting an aromatic carbonyl compound has a difference in stability depending on a substitution type of the aromatic. On the other hand, since diphenylmethanol (DPM) has two aromatic rings, its light absorption range extends to a wider wavelength than when it has one ring. Thus, hydrogen peroxide production ability may be high. Therefore, it can be confirmed that an aromatic structure of the aromatic alcohol and the corresponding aromatic carbonyl compound affects the light absorption and hydrogen peroxide production ability of the organic working solution.

TABLE 2

| | | Organic working solution | | | Production |
|---|---|---|---|---|---|
| | | Reaction amount | | | amount of |
| | Light | of benzyl | | | hydrogen |
| | irradiation | alcohol:organic | Aromatic | Organic | peroxide |
| Division | conditions | solvent | alcohol type | solvent type | (μmol) |
| Example 2-1 | 990 W/m² | 5 mmol:5 ml | benzyl alcohol | Dimethyl | 229.8 |
| | Simulated | | (BzOH) | sulfoxide | |
| Example 2-2 | solar | | 4-fluorobenzyl | (DMSO) | 196.3 |
| | (AM 1.5G) | | alcohol (F-BzOH) | | |
| Example 2-3 | | | 4-methyl benzyl | | 271.5 |
| | | | alcohol (M-BzOH) | | |
| Example 2-4 | | | α-methylbenzyl | | 188.3 |
| | | | alcohol (α-m-BzOH) | | |
| Example 2-5 | | | diphenylmethanol | | 260.7 |
| | | | (DPM) | | |

### (Experimental Example 6) Hydrogen Peroxide Production Ability Depending on Ratio of Aromatic Alcohol in the Organic Working Solution

The production ability of hydrogen peroxide produced according to Examples 3-1 to 3-12 was analyzed.

Hydrogen peroxide production ability was analyzed by a colorimetric method using a titanium sulfate solution. Specifically, a titanium sulfate (24%) solution was diluted to 0.8% with DMSO, and 98% sulfuric acid was added thereto so that the final sulfuric acid concentration was 2 M. The final diluted titanium sulfate solution was added to an organic working solution sample in a volume ratio of 1:1 to 1:2 and stirred for about 1 minute. A mixing ratio between the two solutions may be different depending on a hydrogen peroxide production concentration. Since the sample turns yellow due to the reaction of the titanium sulfate solution and the organic working solution, the hydrogen peroxide production ability may be analyzed by a light absorption value at a wavelength of 405 nm. That is, a quantitative concentration of hydrogen peroxide may be derived using the fact that a degree of color development of a mixed solution of the organic working solution and titanium sulfate varies depending on the concentration of hydrogen peroxide. Alternatively, the degree of hydrogen peroxide production may be compared using the light absorption value (a.u.) depending on the degree of color development.

According to FIGS. 10, 11 and Table 3, it can be seen that when the ratio of the aromatic alcohol in the organic working solution is 70 vol % (when the volume ratio of aromatic alcohol:organic solvent is 7:3), the production amount of hydrogen peroxide is the highest, resulting in the highest production efficiency. Therefore, according to FIGS. 10 and 11, hydrogen peroxide production efficiency may be high when the aromatic alcohol is contained in an amount of 50 vol % to 100 vol % based on the total volume of the organic working solution. However, aforementioned results were derived when acetonitrile was contained as the organic solvent and benzyl alcohol or α-methylbenzyl alcohol was used as the aromatic alcohol. Therefore, an optimal aromatic alcohol content range may also vary depending on the type of organic solvent and aromatic alcohol, and is not limited to the above range.

TABLE 3

| | | Organic working solution | | | |
|---|---|---|---|---|---|
| | | Volume ratio | | | Hydrogen peroxide |
| | Light | of benzyl | | | production efficiency |
| | irradiation | alcohol:organic | Aromatic | Organic | (light absorption |
| Division | conditions | solvent (v:v) | alcohol type | solvent type | value, a.u.) |
| Example 3-1 | 365 nm | 10:90 | benzyl alcohol | acetonitrile | 0.331 |
| Example 3-2 | Ultraviolet | 30:70 | (BzOH) | | 0.956 |
| Example 3-3 | lamp | 50:50 | | | 1.201 |
| Example 3-4 | irradiation | 70:30 | | | 1.353 |
| Example 3-5 | for 10 min | 90:10 | | | 1.171 |
| Example 3-6 | | 100:0 | | | 1.146 |
| Example 3-7 | | 10:90 | α-methylbenzyl | | 0.077 |
| Example 3-8 | | 30:70 | alcohol | | 0.315 |
| Example 3-9 | | 50:50 | (α-m-BzOH) | | 0.601 |
| Example 3-10 | | 70:30 | | | 0.788 |
| Example 3-11 | | 90:10 | | | 0.567 |
| Example 3-12 | | 100:0 | | | 0.376 |

### (Experimental Example 7) Hydrogen Peroxide Production Ability Depending on Organic Solvent Type in the Organic Working Solution

The production performance of hydrogen peroxide produced according to Examples 4-1 to 4-25 was analyzed.

Hydrogen peroxide production ability was analyzed through the colorimetric method with a titanium sulfate solution as in Experimental Example 6.

According to FIG. 12 and Table 4, it can be confirmed that the organic working solution containing 2-hexanone, butanone, chloroform, etc. as an organic solvent exhibits the highest hydrogen peroxide production ability. In the experiment in which the results of FIG. 12 were derived, as the organic solvent, trifluorotoluene, acetonitrile, methanol, ethanol, tert-butanol, 1-propanol, 2-propanol, acetone, ethyl acetate, tert-amyl alcohol, 1-butanol, petroleum ether, pentane, cyclohexane, n-hexane, dichloromethane, chloroform, tetrahydrofuran, 1,4-dioxane, toluene, dimethyl sulfoxide (DMSO), dimethylformamide, 1,2-dichloroethane, 1-octanol, benzonitrile, butanone, cyclohexanone, methyl tert-butyl ether, 2-hexanone, butyl acetate, trichloroethylene, xylene, and ethyl benzene were applied to the organic working solution, respectively, but the type of organic solvent is not limited thereto.

In addition, according to FIG. 12 and Table 4, it can be confirmed that in most of the organic working solutions, when benzyl alcohol (α-methylbenzyl alcohol) substituted with a methyl group as the aromatic alcohol is used, a more improved hydrogen peroxide production ability is exhibited.

TABLE 4

| | | Organic working solution | | | |
|---|---|---|---|---|---|
| | | Volume ratio | | | Hydrogen peroxide |
| | Light | of benzyl | | | production efficiency |
| | irradiation | alcohol:organic | Aromatic | Organic | (light absorption |
| Division | conditions | solvent (v:v) | alcohol type | solvent type | value, a.u.) |
| Example 4-1 | 365 nm | 70:30 | benzyl alcohol | methanol | 0.376 |
| Example 4-2 | Ultraviolet | | (BzOH) | t-butanol | 0.391 |
| Example 4-3 | lamp | | | 2-propanol | 0.315 |
| Example 4-4 | irradiation | | | t-amyl alcohol | 0.75 |
| Example 4-5 | for 5 min | | | acetone | 0.459 |
| Exemple 4-6 | | | | ethyl acetate | 0.574 |
| Example 4-7 | | | | cyclohexane | 0.495 |
| Example 4-8 | | | | 1,2-dichloroethane | 0.495 |
| Example 4-9 | | | | chloroform | 0.475 |
| Example 4-10 | | | | dioxane | 0.688 |
| Example 4-11 | | | | toluene | 0.444 |
| Example 4-12 | | | | acetonitrile | 0.501 |
| Example 4-13 | | | | dimethyl sulfoxide | 0.589 |
| Example 4-14 | | | | dimethylformamide | 0.728 |
| Example 4-15 | | | | trifluorotoluene | 0.377 |
| Example 4-16 | | | | 1-octanol | 0.562 |
| Example 4-17 | | | | benzonitrile | 0.444 |
| Example 4-18 | | | | butanone | 0.744 |
| Example 4-19 | | | | cyclohexanone | 0.825 |
| Example 4-20 | | | | methyl tert-butyl | 0.736 |
| | | | | ether | |
| Example 4-21 | | | | 2-hexanone | 0.839 |
| Example 4-22 | | | | butyl acetate | 0.694 |
| Example 4-23 | | | | trichloroethylene | 0.366 |
| Example 4-24 | | | | xylene | 0.506 |
| Example 4-25 | | | | ethyl benzene | 0.435 |

### (Experimental Example 8) Hydrogen Peroxide Production Ability Depending on Concentration of Benzaldehyde (BzCHO) in Organic Working Solution

The production abilities of hydrogen peroxides produced according to Examples 5-1 to 5-14 were analyzed.

Hydrogen peroxide production ability was analyzed through a colorimetric method with a titanium sulfate solution as in Experimental Example 6.

In this Experimental Example 8, since the aromatic carbonyl compound self-oxidized and contained in the aromatic alcohol serves as an auto-catalyst, it was intended to confirm whether the hydrogen peroxide production efficiency can be increased by adding the aromatic carbonyl compound thereto.

Benzyl alcohol and substituted benzyl alcohol may act as a hydrogen donor, and as the auto-catalyst benzaldehyde may act as a hydrogen acceptor. According to FIG. 13 and Table 5, when benzyl alcohol was applied as a hydrogen donor, the highest hydrogen peroxide production ability was exhibited when benzaldehyde (BzCHO) was added in a volume ratio of 1% to 5%. Meanwhile, according to FIG. 14 and Table 5, when α-methylbenzyl alcohol, which is a substituted benzyl alcohol, was applied as the hydrogen donor, the highest hydrogen peroxide production ability was shown when benzaldehyde (BzCHO) was added in an amount of 1% to 10% by volume.

Specifically, the reason why the reaction efficiency greatly decreases as the number of the aromatic carbonyl compounds (aromatic ketones (or aldehydes)) increases in the reaction is that the radicals formed in the reaction do not activate oxygen molecules and form a dimer through bonding between radicals. Therefore, it can be seen that there is an optimal ratio of an aromatic carbonyl compound that acts as an auto-catalyst, such as benzaldehyde, and that the optimal efficiency was generally shown at a level of 1 to 10%. However, the amount of the aromatic carbonyl compound added applicable to the hydrogen peroxide production method of the present invention is not limited thereto.

TABLE 5

| | | Organic working solution | | | | Hydrogen |
|---|---|---|---|---|---|---|
| | | Volume | | | | peroxide |
| | | ratio of | | | | production |
| | | benzyl | | | | efficiency |
| | | alcohol: | | | Amount of | light |
| | Light | organic | Aromatic | Organic | benzaldehyde | absorption |
| | Irradiation | solvent | alcohol | solvent | added | value |
| Division | conditions | (v:v) | type | type | (vol %) | [symbol] |
| Example 5-1 | 365 nm | 70:30 | benzyl | acetonitrile | 0 | 0.29 |
| Example 5-2 | Ultraviolet | | alcohol | | 0.1 | 0.504 |
| Example 5-3 | lamp | | (BzOH) | | 1 | 1.102 |
| Example 5-4 | Irradiation | | | | 5 | 1.031 |
| Example 5-5 | for 5 min | | | | 10 | 0.59 |
| Example 5-6 | | | | | 20 | 0.364 |
| Example 5-7 | | | | | 30 | 0.04 |
| Example 5-8 | | | α-methylbenzyl | | 0 | 0.417 |
| Example 5-9 | | | alcohol | | 0.1 | 0.588 |
| Example 5-10 | | | (α-m-BzOH) | | 1 | 0.713 |
| Example 5-11 | | | | | 5 | 0.833 |
| Example 5-12 | | | | | 10 | 0.752 |
| Example 5-13 | | | | | 20 | 0.343 |
| Example 5-14 | | | | | 30 | 0.019 |

[symbol]

indicates data missing or illegible when filed

### (Experimental Example 9) Confirmation of Generation of Active Species in Organic Working Solution and Photochemical Hydrogen Peroxide Production Mechanism

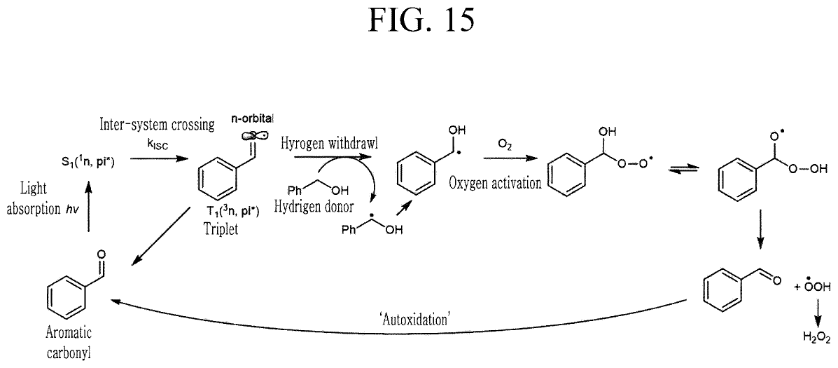

The mechanism of the hydrogen peroxide production reaction by the photochemical reaction in the organic working solution is shown in FIG. 15. According to FIG. 15, the aromatic carbonyl compound is excited by absorbing ultraviolet-near-visible light, and then may form a triplet through inter-system crossing. A triplet n,π* electronic state formed on a carbonyl oxygen atom with an n-orbital may abstract a hydrogen atom from an aromatic alcohol. Thus, the excited aromatic carbonyl compound and aromatic alcohol may form α-hydroxylbenzyl radicals. Since this radical has the property of activating oxygen molecules, aromatic ketones and peroxide (OOH) radicals may be obtained through the addition and removal of oxygen molecules. Then, OOH may generate hydrogen peroxide via electron/hydrogen supply in the reaction.

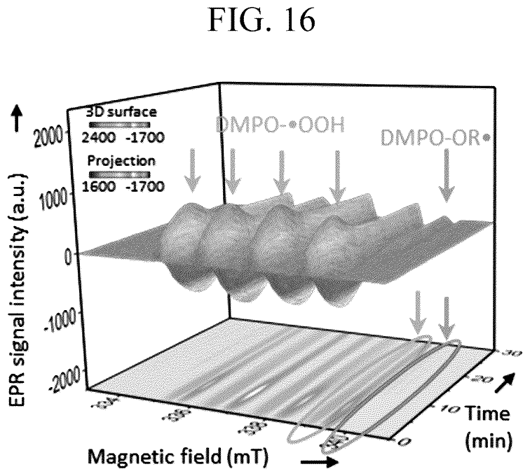

In addition, in order to verify the mechanism of the actual hydrogen peroxide production reaction, active species (radicals) formed in the organic working solution were experimentally observed. The benzyl radical formed from the hydrogen donor through a hydrogen atom transfer reaction of the aromatic carbonyl compound as a hydrogen acceptor and the peroxide (OOH) radical formed through the subsequent activation of oxygen were observed by Electron Paramagnetic Resonance (EPR) spectra. As illustrated in FIG. 16, in the representative reaction, after adding 5,5-dimethyl-1-pyrroline-N-oxide (DMPO, 1.33 μl), which is a probe molecule that combines with radicals to enable observation, to the organic working solution (100 μl) composed of 50:50 vol/vol % of benzyl alcohol and acetonitrile, oxygen was charged, and the formation of active species was observed in real time while irradiating light. As a result, peaks of DMPO-OR, which is a spin adduct of benzyl radical and DMPO probe, and DMPO-OOH, which is a spin adduct of peroxide (OOH) radical and DMPO probe, were clearly observed in the organic working solution. In the EPR measurement, the DMPO-OOH spin adduct by peroxide radical showed peaks of g=2.00561; AN=13.5 G; AH,b=11.0 G; AH,g=1.30 G, and the DMPO-OR spin adduct by benzyl radical showed peaks of g=2.00561; AN=15.3 G; AH=22.2 G. Through the above measurement, it can be confirmed that the photochemical hydrogen peroxide production mechanism in the organic working solution is based on the hydrogen atom transfer reaction.

What is claimed is:

1. An organic working solution used for producing hydrogen peroxide by photo-autoxidation,
wherein the organic working solution contains a mixture of an aromatic alcohol and an organic solvent, and
the aromatic alcohol contains 0.1% to 0.2% by weight of an aromatic carbonyl compound based on the total weight of the aromatic alcohol.

2. The organic working solution of claim 1, wherein
the organic working solution contains an additionally mixed aromatic carbonyl compound.

3. The organic working solution of claim 2, wherein
the additionally mixed aromatic carbonyl compound is one or more selected among an aromatic ketone or an aromatic aldehyde.

4. The organic working solution of claim 3, wherein
the aromatic ketone or the aromatic aldehyde is one or more selected among benzaldehyde (BzCHO), 9-anthracenecarboxaldehyde, 9-anthraldehyde, 9-phenanthrenecarboxaldehyde, fluorene-2-carboxaldehyde, 1-pyrenecarboxaldehyde, 1-naphthaldehyde, 2-naphthaldehyde, biphenyl-4-carboxaldehyde, benzophenone, 4-methylbenzaldehyde (p-tolualdehyde), 3-methylbenzaldehyde (m-tolualdehyde), 2-methylbenzaldehyde (o-tolualdehyde), 4-chlorobenzaldehyde, 3-chlorobenzaldehyde, 2-chlorobenzaldehyde, 4-fluorobenzaldehyde, 3-fluorobenzaldehyde, 2-fluorobenzaldehyde, 4-bromobenzaldehyde, 3-bromobenzaldehyde, 2-bromobenzaldehyde, 1-(p-tolyl)ethanone, 1-(4-fluorophenyl)ethanone, p-anisaldehyde, 4-formylbenzonitrile, 4-methoxyacetophenone, 4-acetylbenzonitrile, anthraquinone, fluorenone, acetophenone, xanthone, and thioxanthone.

5. The organic working solution of claim 2, wherein
the aromatic carbonyl compound is additionally mixed in a range of 0.001% to 30 vol % based on the total volume of a mixture of the aromatic alcohol, the organic solvent, and the additionally mixed aromatic carbonyl compound.

6. The organic working solution of claim 1, wherein
the aromatic alcohol is one or more selected from the group consisting of benzyl alcohol substituted with electron-withdrawing and electron-donating functional groups.

7. The organic working solution of claim 6, wherein
the group consisting of the benzyl alcohol substituted with the electron-withdrawing and electron-donating functional groups includes enzyl alcohol (BzOH), 4-fluorobenzyl alcohol (F-BzOH), 3-fluorobenzyl alcohol, 2-fluorobenzyl alcohol, 4-methylbenzyl alcohol (M-BzOH), 3-methylbenzyl alcohol, 2-methylbenzyl alcohol, α-methylbenzyl alcohol (α-M-BzOH), diphenylmethanol (DPM), and cinnamyl alcohol.

8. The organic working solution of claim 1, wherein
the aromatic alcohol is mixed in a volume ratio of 1:99 to 99:1 based on a volume of the organic solvent mixed in the organic working solution.

9. The organic working solution of claim 1, wherein
an oxygen solubility of the organic solvent is 1 mM to 15 mM based on 1 atm.

10. The organic working solution of claim 1, wherein
the organic solvent includes a hydrophobic organic solvent, and
an octanol-water partition coefficient (log P) value of the hydrophobic organic solvent represented by the following Equation 1 is 0 or more:
Octanol-water partition coefficient=log P=log([C_{oct}]/[C_{water}]) [Equation 1]
wherein [C_{oct}] refers to a mol concentration of the organic solvent dissolved in an octanol layer, and [C_{water}] refers to a mol concentration of the organic solvent dissolved in a water layer.

11. The organic working solution of claim 1, wherein
the organic solvent is one or more selected among trifluorotoluene, acetonitrile, methanol, ethanol, tert-butanol, 1-propanol, 2-propanol, acetone, ethyl acetate, tert-amyl alcohol, 1-butanol, petroleum ether, pentane, cyclohexane, n-hexane, dichloromethane, chloroform, tetrahydrofuran, 1,4-dioxane, toluene, dimethyl sulfoxide (DMSO), dimethylformamide, 1,2-dichloroethane, 1-octanol, benzonitrile, butanone, cyclohexanone, methyl tert-butyl ether, 2-hexanone, butyl acetate, trichloroethylene, xylene, and ethyl benzene.

12. A method for producing hydrogen peroxide by photo-autoxidation utilizing an organic working solution, comprising:
preparing an organic working solution for photo-autoxidation and introducing the organic working solution into a reactor;
supplying oxygen to the reactor to form an oxygen-saturated mixed solution; and
irradiating the oxygen-saturated mixed solution with light to produce hydrogen peroxide.

13. The method of claim 12, wherein
in the preparing of the organic working solution for photo-autoxidation and introducing the organic working solution into the reactor,
the organic working solution contains a mixture of an aromatic alcohol and an organic solvent, and
the aromatic alcohol contains 0.1% to 0.2% by weight of an aromatic carbonyl compound based on the total weight of the aromatic alcohol.

14. The method of claim 13, wherein
the organic working solution contains an additionally mixed aromatic carbonyl compound.

15. The method of claim 14, wherein
the additionally mixed aromatic carbonyl compound is one or more selected among an aromatic ketone or an aromatic aldehyde.

16. The method of claim 15, wherein
the aromatic ketone or the aromatic aldehyde is one or more selected among benzaldehyde (BzCHO), 9-anthracenecarboxaldehyde, 9-anthraldehyde, 9-phenanthrenecarboxaldehyde, fluorene-2-carboxaldehyde, 1-pyrenecarboxaldehyde, 1-naphthaldehyde, 2-naphthaldehyde, biphenyl-4-carboxaldehyde, benzophenone, 4-methylbenzaldehyde (p-tolualdehyde), 3-methylbenzaldehyde (m-tolualdehyde), 2-methylbenzaldehyde (o-tolualdehyde), 4-chlorobenzaldehyde, 3-chlorobenzaldehyde, 2-chlorobenzaldehyde, 4-fluorobenzaldehyde, 3-fluorobenzaldehyde, 2-fluorobenzaldehyde, 4-bromobenzaldehyde, 3-bromobenzaldehyde, 2-bromobenzaldehyde, 1-(p-tolyl)ethanone, 1-(4-fluorophenyl)ethanone, p-anisaldehyde, 4-formylbenzonitrile, 4-methoxyacetophenone, 4-acetylbenzonitrile, anthraquinone, fluorenone, acetophenone, xanthone, and thioxanthone.

17. The method of claim 14, wherein
the aromatic carbonyl compound is additionally mixed in a range of 0.001% to 30 vol % based on the total volume of a mixture of the aromatic alcohol, the organic solvent, and the additionally mixed aromatic carbonyl compound.

18. The method of claim 13, wherein
the aromatic alcohol is one or more selected from the group consisting of the benzyl alcohol substituted with electron-withdrawing and electron-donating functional groups.

19. The method of claim 18, wherein
the group consisting of the benzyl alcohol substituted with the electron-withdrawing and electron-donating functional groups includes benzyl alcohol (BzOH), 4-fluorobenzyl alcohol (F-BzOH), 3-fluorobenzyl alcohol, 2-fluorobenzyl alcohol, 4-methylbenzyl alcohol (M-BzOH), 3-methylbenzyl alcohol, 2-methylbenzyl alcohol, α-methylbenzyl alcohol (α-M-BzOH), diphenylmethanol (DPM), and cinnamyl alcohol.

20. The method of claim 13, wherein
the aromatic alcohol is mixed in a volume ratio of 1:99 to 99:1 based on a volume of the organic solvent mixed in the organic working solution.

21. The method of claim 13, wherein
an oxygen solubility of the organic solvent is 1 mM to 15 mM based on 1 atm.

22. The method of claim 13, wherein
the organic solvent includes a hydrophobic organic solvent, and
an octanol-water partition coefficient (log P) value of the hydrophobic organic solvent represented by the following Equation 1 is 0 or more:
Octanol-water partition coefficient=log P=log([C_{oct}]/[C_{water}]) [Equation 1]
wherein [C_{oct}] refers to a mol concentration of the organic solvent dissolved in an octanol layer, and [C_{water}] refers to a mol concentration of the organic solvent dissolved in a water layer.

23. The method of claim 13, wherein
the organic solvent is one or more selected among trifluorotoluene, acetonitrile, methanol, ethanol, tert-butanol, 1-propanol, 2-propanol, acetone, ethyl acetate, tert-amyl alcohol, 1-butanol, petroleum ether, pentane, cyclohexane, n-hexane, dichloromethane, chloroform, tetrahydrofuran, 1,4-dioxane, toluene, dimethyl sulfoxide (DMSO), dimethylformamide, 1,2-dichloroethane, 1-octanol, benzonitrile, butanone, cyclohexanone, methyl tert-butyl ether, 2-hexanone, butyl acetate, trichloroethylene, xylene, and ethyl benzene.

24. The method of claim 12, wherein
in the supplying of the oxygen to the reactor to form the oxygen-saturated mixed solution,
an oxygen supply rate is in a range of 10 mL/min to 50 mL/min.

25. The method of claim 12, wherein
in the supplying of the oxygen to the reactor to form the oxygen-saturated mixed solution,
an oxygen supply time is in a range of 15 min to 60 min.

26. The method of claim 12, wherein
in the irradiating of the oxygen-saturated mixed solution with the light to produce the hydrogen peroxide,
the light having a light wavelength of 200 nm to 500 nm band is irradiated.

27. The method of claim 12, wherein
in the irradiating of the oxygen-saturated mixed solution with the light to produce the hydrogen peroxide,
the light is irradiated for 0 to 60 hours and
an irradiation time of the light exceeds 0.

28. The method of claim 12, wherein
in the irradiating of the oxygen-saturated mixed solution with the light to produce the hydrogen peroxide,
the light with an irradiance of 10 W/m² to 1000 W/m² is irradiated.
